(19) United States
(12) Patent Application Publication
(10) Pub. No.: US 2016/0065941 A1
(43) Pub. Date: Mar. 3, 2016

(54) THREE-DIMENSIONAL IMAGE CAPTURING APPARATUS AND STORAGE MEDIUM STORING THREE-DIMENSIONAL IMAGE CAPTURING PROGRAM

(71) Applicant: CANON KABUSHIKI KAISHA, Tokyo (JP)

(72) Inventors: Takashi Oniki, Utsunomiya-shi (JP); Chiaki Inoue, Utsunomiya-shi (JP)

(21) Appl. No.: 14/840,560

(22) Filed: Aug. 31, 2015

(30) Foreign Application Priority Data
Sep. 3, 2014 (JP) 2014-179633

(51) Int. Cl. H04N 13/02; G06T 5/50; H04N 13/00

(52) U.S. Cl. CPC H04N 13/0239; H04N 13/0007; H04N 13/0022; H04N 13/0225; H04N 13/0278; G06T 5/50; G06T 2207/10021; G06T 2207/20221

(57) ABSTRACT

The three-dimensional image capturing apparatus includes an image capturer performing image capturing to produce parallax images, an extractor extracting an object included in the parallax images, a first determiner determining whether the parallax images allow three-dimensional image fusion by an observer observing the parallax images, by using determination-purpose information on one of a parallax amount of the object between the parallax images and a distance to the object at the image capturing and a fusional limit, a second determiner determining a three-dimensional effect of the object in the observation of the parallax images, by using the determination-purpose information and a lowest allowable parallax value that is a lower limit of the parallax amount allowing the observer to feel the three-dimensional effect, and a controller controlling an image capturing parameter in the image capturer depending on determination results by the first and the second determiners.

### BACKGROUND OF THE INVENTION

1. Field of the Invention

The present invention relates to a three-dimensional image capturing apparatus that produces parallax images providing a three-dimensional effect.

2. Description of the Related Art

Displaying left-eye and right-eye parallax images (hereinafter referred to as “left and right parallax images”) produced by image capturing of an object from two viewpoints and having a parallax from each other can present a three-dimensional image to an observer. However, when a parallax amount between the left and right parallax images exceeds a limit value allowing the observer to fuse the left and right parallax images into a single three-dimensional image, which is called a fusional limit, the observer recognizes the left and right parallax images as a double image.

A conventional method is proposed which controls, based on an assumption of a size of a display screen on which the parallax images are displayed and an observation distance (visual distance) between the observer and the display screen, image capturing parameters (such as a base length and an angle of convergence) for image capturing from left and right viewpoints depending on an object distance such that the parallax amount does not exceed the fusional limit. Furthermore, Japanese Patent Laid-open No. 07-167633 discloses a three-dimensional image capturing apparatus integrated with a display apparatus. This three-dimensional image capturing apparatus calculates a parallax amount between left and right parallax images produced by image capturing and calculates a reproduction depth position of a three-dimensional image based on the parallax amount and a display condition (observation condition) of the display apparatus that displays the parallax images. Then, depending on information on the reproduction depth position, the three-dimensional image capturing apparatus adjusts the base length and the angle of convergence such that the parallax amount does not exceed the fusional limit of an observer.

However, the three-dimensional image capturing apparatus disclosed in Japanese Patent Laid-open No. 07-167633 is focused only on the fusional limit of the observer and adjusts the base length and the angle of convergence such that the parallax amount does not exceed the fusional limit, without a three-dimensional effect of the object felt by the observer being considered. Thus, even if the parallax amount is adjusted to be below the fusional limit of the observer, a favorable three-dimensional image cannot be presented as long as the three-dimensional effect of the object felt by the observer is insufficient.

### SUMMARY OF THE INVENTION

The present invention provides a three-dimensional image capturing apparatus capable of producing parallax images not only allowing three-dimensional image fusion by an observer but also provision of a sufficient three-dimensional effect to the observer.

The present invention provides as an aspect thereof a three-dimensional image capturing apparatus including an image capturer configured to perform image capturing to produce parallax images mutually having a parallax, an extractor configured to extract an object included in the parallax images, a first determiner configured to determine whether or not the parallax images allow three-dimensional image fusion by an observer observing the parallax images, by using determination-purpose information on one of a parallax amount of the object between the parallax images and a distance to the object at the image capturing and a fusional limit that is an upper limit of the parallax amount allowing the three-dimensional image fusion by the observer, a second determiner configured to determine a three-dimensional effect of the object in the observation of the parallax images, by using the determination-purpose information and a lowest allowable parallax value that is a lower limit of the parallax amount allowing the observer to feel the three-dimensional effect, and a controller configured to control an image capturing parameter in the image capturer depending on determination results by the first and the second determiners.

The present invention provides as another aspect thereof a non-transitory computer-readable storage medium storing a three-dimensional image capturing program as a computer program that causes a computer of a three-dimensional image capturing apparatus to perform an image capturing control process. The image capturing apparatus including an image capturer configured to perform image capturing to produce parallax images mutually having a parallax. The image capturing control process includes extracting an object included in the parallax images, acquiring determination-purpose information on one of a parallax amount of the object between the parallax images and a distance to the object at the image capturing, determining whether or not the parallax images allow three-dimensional image fusion by an observer observing the parallax images, by using the determination-purpose information and a fusional limit that is an upper limit of the parallax amount allowing the three-dimensional image fusion by the observer, determining a three-dimensional effect of the object in the observation of the parallax images, by using the determination-purpose information and a lowest allowable parallax value that is a lower limit of the parallax amount allowing the observer to feel the three-dimensional effect, and controlling an image capturing parameter in the image capturer depending on a determination result of whether or not the parallax images allow the three-dimensional image fusion and a determination result of the three-dimensional effect.

Further features and aspects of the present invention will become apparent from the following description of exemplary embodiments with reference to the attached drawings.

### BRIEF DESCRIPTION OF THE DRAWINGS

FIG. 1 is a block diagram of a configuration of a three-dimensional image capturing apparatus that is Embodiment 1 of the present invention.

FIG. 2 is a block diagram of a configuration of a three-dimensional image processor in the three-dimensional image capturing apparatus of Embodiment 1.

FIG. 3 is a flowchart of processes performed by the three-dimensional image capturing apparatus of Embodiment 1.

FIG. 4A and FIG. 4B illustrate a corresponding point extraction method.

FIG. 5 is a block diagram of a configuration of a three-dimensional image processor in a three-dimensional image capturing apparatus that is Embodiment 2 of the present invention.

FIG. 6 is a flowchart of processes performed by the three-dimensional image capturing apparatus of Embodiment 2.

FIG. 7 is a flowchart of processes performed by a three-dimensional image capturing apparatus that is Embodiment 3 of the present invention.

FIG. 8 is a block diagram of a configuration of a three-dimensional image processor in a three-dimensional image capturing apparatus that is Embodiment 4 of the present invention.

FIG. 9 is a flowchart of processes performed by the three-dimensional image capturing apparatus of Embodiment 4.

FIG. 10 is a block diagram of a configuration of a three-dimensional image processor in a three-dimensional image capturing apparatus that is Embodiment 5 of the present invention.

FIG. 11 is a flowchart of processes performed by the three-dimensional image capturing apparatus of Embodiment 5.

FIG. 12 is a block diagram of a configuration of a three-dimensional image processor in a three-dimensional image capturing apparatus that is Embodiment 6 of the present invention.

FIG. 13 is a flowchart of processes performed by the three-dimensional image capturing apparatus of Embodiment 6.

FIGS. 14A to 14D illustrate a configuration of a three-dimensional image capturing apparatus that is Embodiment 7 of the present invention.

FIGS. 15A to 15C are diagrams for describing a three-dimensional image capturing model.

FIG. 16 is a diagram for describing an object extraction.

### DESCRIPTION OF THE EMBODIMENTS

Exemplary embodiments of the present invention will be described below with reference to the accompanied drawings.

First, description will be made of features common to the embodiments before specific descriptions thereof. A three-dimensional image capturing apparatus that is each of the embodiments performs image capturing of an object by two image capturers (hereinafter referred to as “right and left cameras”) disposed at right and left viewpoints different from each other, and produces parallax images for right and left eyes (hereinafter referred to as “right and left parallax images”) having a parallax therebetween. These right and left parallax images can present a three-dimensional image (three-dimensional object image) to an observer observing the right and left parallax images with his/her right and left eyes.

Parameters of the three-dimensional image include five parameters of image capturing (hereinafter referred to as “image capturing parameters”) and three parameters of observation (hereinafter referred to as “observation parameters”). The five image capturing parameters include a base length as a distance between optical axes of the right and left cameras, a focal length of each camera at image capturing, a size (numbers of effective pixels) of an image sensor of each camera, an angle formed by the optical axes of the cameras (angle of convergence) and a distance to the object (object distance). The three observation parameters include a size of a display surface on which the parallax images are displayed, a visual distance as a distance between the display surface and the observer observing the parallax images displayed on the display surface and an offset amount for adjusting positions of the parallax images displayed on the display surface.

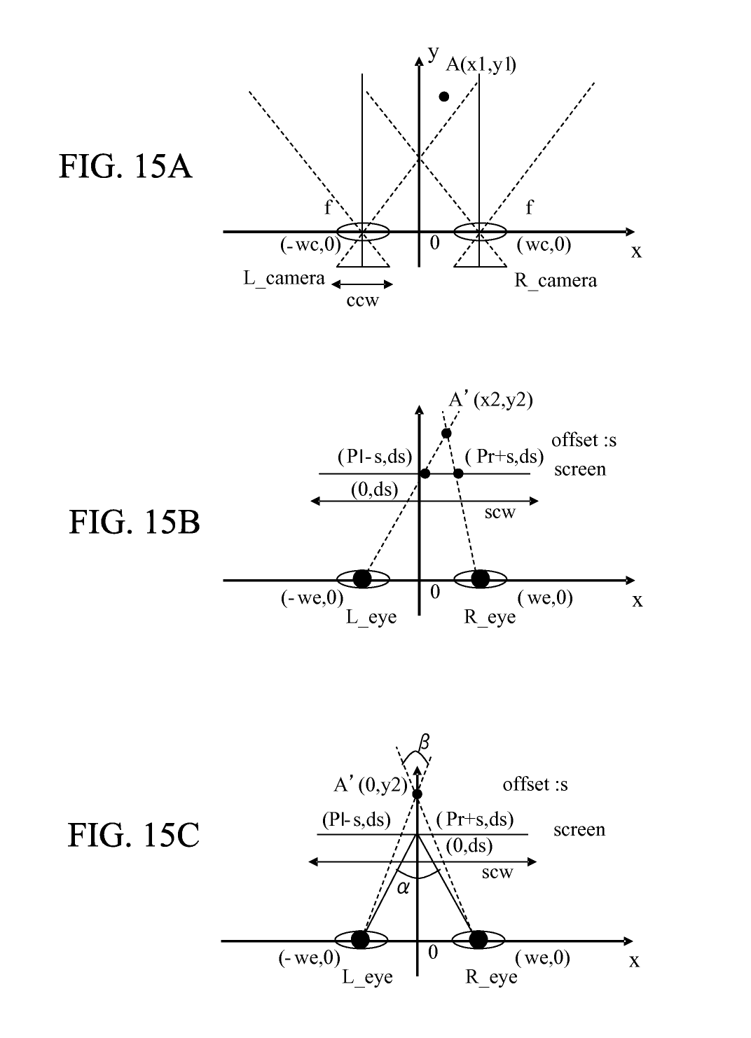

Three-dimensional effect can be controlled by changing the angle of convergence (moving a convergence point as an intersection point of the right and left optical axes in a front-and-rear direction), which is called an intersection method. In the specification, however, description will be made of the three-dimensional effect controlled by a parallel method in which the optical axes of the right and left cameras are mutually parallel, for simplicity. A geometric theory for the parallel method also holds for the method in which the angle of convergence is changed, with a distance to the convergence point taken into account. FIG. 15A illustrates a geometric relation when parallax images of an object are captured, and FIGS. 15B and 15C each illustrate a geometric relation when the parallax images produced through the image capturing are presented to the observer.

In FIG. 15A, an origin is defined as a central point between principal point positions of the right and left cameras. An x-axis is defined to be in a horizontal direction in which the right and left cameras (L_camera and R_camera) are arranged, and a y-axis is defined to be in a front-and-rear direction orthogonal to the x axis. A height direction is omitted in FIGS. 15A, 15B and 15C, for simple description. The base length is represented by 2wc. The right and left cameras have identical specifications, the image capturing optical systems of the cameras each have a focal length f at image capturing, and the image sensors each have a horizontal width ccw. A position of an object A is represented by A(x1,y1).

A position of an optical image of the object A formed on each of the image sensors of the right and left cameras geometrically corresponds to an intersection point of the image sensor with a straight line passing through the object A and the principal point position of each camera. Thus, between the right and left cameras, the positions of the optical images of the object A on the respective image sensors with respect to their centers are different. This positional difference is smaller for a longer object distance, reaching zero for an infinite object distance.

In FIG. 15B, an origin is defined as a central point between the right and left eyes (R_eye and L_eye) of the observer, an x-axis is defined to be in a horizontal direction in which the right and left eyes are arranged, and a y-axis is defined to be in a front-and-rear direction orthogonal to the x axis. A distance between the right and left eyes is represented by 2we. The visual distance from the observer to the display surface (screen) on which the parallax images are displayed is represented by ds. The display surface has a horizontal width scw.

The right and left parallax images obtained through image capturing by the right and left cameras are displayed in display regions substantially overlapping with each other on the display surface. When the observer puts on liquid crystal shutter glasses, which alternately open and close shutters for the right and left eyes, to perform three-dimensional image observation, the right and left parallax images displayed on the display surface are alternately switched fast in synchronization with the opening and closing of the shutters. When the right and left parallax images obtained through image capturing by the parallel method are displayed without being processed, images of infinite objects are dominantly displayed on the display surface, and thus all objects are displayed popping out from the display surface, which is not preferable. For this reason, the display regions of the right and left parallax images are shifted from each other in the horizontal direction along the x-axis to appropriately adjust the object distances at the display surface. An amount of the shift of the display regions of the right and left parallax images corresponds to the offset amount (s).

When the offset amount is zero, coordinates of the left parallax image L displayed on the display surface are represented by (Pl,ds), and coordinates of the right parallax image R displayed on the display surface are represented by (Pr,ds). When the offset amount is s, the coordinates of the left parallax image L are (Pl−s,ds), and the coordinates of the right parallax image R are (Pr+s,ds).

A three-dimensional image of the object A observed with this condition is formed at a position A′(x2,y2) of an intersection point of a straight line connecting the left eye and the left parallax image and a straight line connecting the right eye and the right parallax image.

Detailed geometric description will be made of the position A′(x2,y2). Shift amounts of the parallax images of the object A with respect to the centers of the image sensors of the right and left cameras, which are referred to as “image capturing parallax amounts Plc and Prc”, are given by following expressions (1) and (2).

$$\begin{matrix}Prc = \frac{wc - x 1}{y 1} \cdot f & ( 1 ) \\ Plc = \frac{wc + x 1}{y 1} \cdot f & ( 2 )\end{matrix}$$

A ratio of the size (width ccw) of the image sensor and the size (width scw) of the display surface, which is referred to as “a display magnification m”, is given by:

m=scw/ccw.

With this notation, the image capturing parallax amounts Plc and Prc are multiplied with −m at the display surface to obtain display parallax amounts Pl and Pr as expressed by following expressions (3) and (4).

Pr==m·Pr c (3)

Pl=−m·Plc (4)

The offset amount added to the right and left parallax images when displayed is s, and thus the position A′(x2,y2) of the three-dimensional image of the object A observed by the observer is given by following expressions (5) and (6).

$$\begin{matrix}x 2 = \frac{Pl + Pr}{2 we + Pl - Pr - 2 s} \cdot we & ( 5 ) \\ y 2 = \frac{2 we}{2 we + Pl - Pr - 2 s} \cdot ds & ( 6 )\end{matrix}$$

Images of an object at an identical object distance are observed on an identical plane. When the object A is assumed to be on the y-axis (x1=0) for simplicity, the display parallax amounts for the offset amount of 0 are given by following expressions (7) and (8).

$$\begin{matrix}Pr = - m \cdot \frac{wc}{y 1} \cdot f & ( 7 ) \\ Pl = m \cdot \frac{wc}{y 1} \cdot f & ( 8 )\end{matrix}$$

As illustrated in FIG. 15C, the position A′ of the three-dimensional image when the offset amount is s is a position (0, y2) of the intersection point of the straight line connecting the left eye and the left parallax image and the straight line connecting the right eye and the right parallax image. The coordinate y2 is expressed by following expression (9).

$$y 2 = \frac{2 we}{2 we + Pl - Pr - 2 s} \cdot ds \qquad ( 9 )$$

Substituting expressions (7) and (8) into expression (9) provides expression below.

$$y 2 = \frac{we \cdot ds}{we - s + \frac{scw \cdot f \cdot wc}{ccw \cdot y 1}} \qquad ( 10 )$$

As illustrated in FIG. 15C, β represents an angle at which the observer observes the three-dimensional image of the object A, which is given by following expression (11) using the distance 2we and the distance y2 from the observer to a position at which the three-dimensional image is formed.

$$β = 2 \cdot arctan \frac{we}{y 2} ≅ \frac{2 we}{y 2} \qquad ( 11 )$$

Substituting expression (9) into y2 provides expression below.

$$β = 2 \cdot [ \frac{Pl - Pr}{2 ds} + \frac{we}{ds} - \frac{s}{ds} ] \qquad ( 12 )$$

As illustrated in FIG. 15C, α represents an angle at which the observer observes the display surface, which is given by following expression (13).

$$α ≅ \frac{2 we}{ds} \qquad ( 13 )$$

A difference α-β is given by following expression (14).

$$α - β = - 2 \cdot [ \frac{Pl - Pr}{2 ds} - \frac{s}{ds} ] \qquad ( 14 )$$

Substituting expressions (7) and (8) into expression (14) provides following expression (15).

$$α - β = - 2 \cdot [ \frac{scw}{ds} \cdot \frac{f}{ccw} \cdot \frac{wc}{y 1} - \frac{s}{ds} ] \qquad ( 15 )$$

The difference α-β is an index called a relative parallax amount. The relative parallax amount corresponds to a distance between the display surface and the image of the object A in a depth direction (the front-and-rear direction along the y-axis). Various researches have found that a human being calculates the relative parallax amount in his/her brain and recognizes the position of the object in the depth direction.

Next, description of will be made of planarization. The planarization refers to such a phenomenon during observation of the three-dimensional image that no distinction (no relative three-dimensional effect) can be obtained in the depth direction between a particular object and any object located at infinity. In other words, the particular object is observed as if pinned to a background at infinity.

Since the planarization is a phenomenon occurring with respect to a distant object, the relative parallax amount is first calculated for the object at infinity. In the parallel method, since a parallax amount (Pl-Pr) is zero as understood from Expressions (1) and (2), the relative parallax amount for the object at infinity is given by following expression (16).

$$α - {β}_{∞} = 2 \cdot \frac{s}{ds} \qquad ( 16 )$$

A parallax amount of an object at a finite distance relative to the object at infinity is calculated by subtracting expression (14) or expression (15) from expression (16) as expressed by following expression (17) or (18).

$$\begin{matrix}β - {β}_{∞} = \frac{Pl - Pr}{2 ds} & ( 17 ) \\ β - {β}_{∞} = 2 \cdot \frac{scw}{ds} \cdot \frac{f}{ccw} \cdot \frac{wc}{y 1} & ( 18 )\end{matrix}$$

Since the distant object looks plane in the planarization, a parallax amount for the object at infinity needs to be zero.

A subjective evaluation of the three-dimensional effect of the distant object by the inventor using a 3D television of full high definition has found that, though a parallax is present between parallax images, most participants (observers) do not perceive the parallax when the object at infinity has a parallax amount of less than three arcminutes. Expressions (17) and (18) do not depend on the distance 2we.

Thus, a parallax amount for which most people perceive no parallax, in other words, have no three-dimensional effect, is defined as a lowest allowable parallax value δt. Use of expression (17) or (18) and δt provides following expressions (19) and (20):

$$\begin{matrix}\vert \frac{Pl - Pr}{ds} \vert \geq δ t & ( 19 ) \\ \vert \frac{Pl - Pr}{ds} \vert < δ t , & ( 20 )\end{matrix}$$

or following expressions (21) and (22):

$$\begin{matrix}\vert 2 \cdot \frac{scw}{ds} \cdot \frac{f}{ccw} \cdot \frac{wc}{y 1} \vert \geq δ t & ( 21 ) \\ \vert 2 \cdot \frac{scw}{ds} \cdot \frac{f}{ccw} \cdot \frac{wc}{y 1} \vert < δ t . & ( 22 )\end{matrix}$$

This allows such a determination to be made that no planarization is produced when expression (19) or expression (21) is satisfied and that the planarization is produced when expression (20) or expression (22) is satisfied.

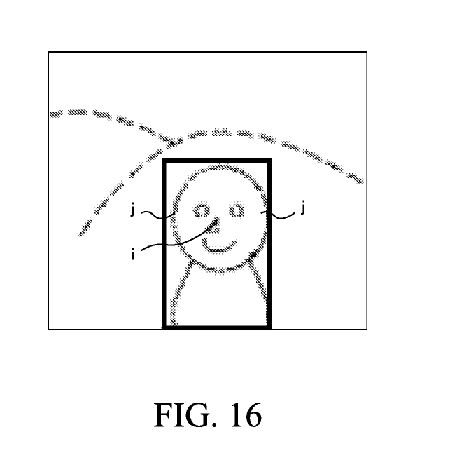

The lowest allowable parallax value δt is applied in a case of a close distance object that has a thickness in the depth direction, such as a person. For example, as illustrated in FIG. 16, in a face of a person located at a close distance, a head of his/her nose is set as a close object i, and each ear is set as a distant object j. To calculate a parallax amount of the object i relative to the object j, a relative parallax amount for the object i is subtracted from a relative parallax amount for the object j in a similar manner to the derivation of Expressions (17) and (18), and therefore following expressions (23) and (24) are obtained.

$$\begin{matrix}( α - {β}_{j} ) - ( α - {β}_{i} ) = {β}_{i} - {β}_{j} = \frac{( {Pl}_{i} - {Pr}_{i} ) - ( {Pl}_{j} - {Pr}_{j} )}{ds} & ( 23 ) \\ ( α - {β}_{j} ) - ( α - {β}_{i} ) = {β}_{i} - {β}_{j} = 2 \cdot ( \frac{wc \cdot scw \cdot f}{ds \cdot ccw} ) \cdot ( \frac{1}{y {1}_{i}} - \frac{1}{y {1}_{j}} ) & ( 24 )\end{matrix}$$

The inventor confirmed, using parallax images of a person as an object while the image capturing parameters other than the base length 2wc and the observation parameter are kept constant, that no three-dimensional effect of the face of the person is provided with the parallax amount of less than three arcminutes, similarly to the planarization. This shows that the lowest allowable parallax value δt is applicable not only to a parallax amount of a distant object but also to a parallax amount of a close distance object. Thus, from expression (23) or (24) and the lowest allowable parallax value δt, following expressions (25) and (26) are obtained:

$$\begin{matrix}\vert \frac{( {Pl}_{i} - {Pr}_{i} ) - ( {Pl}_{j} - {Pr}_{j} )}{ds} \vert \geq δ t & ( 25 ) \\ \vert \frac{( {Pl}_{i} - {Pr}_{i} ) - ( {Pl}_{j} - {Pr}_{j} )}{ds} \vert < δ t & ( 26 )\end{matrix}$$

or following expressions (27) and (28) are obtained:

$$\begin{matrix}\vert 2 \cdot ( \frac{wc \cdot scw \cdot f}{ds \cdot ccw} ) \cdot ( \frac{1}{y {1}_{i}} - \frac{1}{y {1}_{j}} ) \vert \geq δ t & ( 27 ) \\ \vert 2 \cdot ( \frac{wc \cdot scw \cdot f}{ds \cdot ccw} ) \cdot ( \frac{1}{y {1}_{i}} - \frac{1}{y {1}_{j}} ) \vert < δ t . & ( 28 )\end{matrix}$$

Satisfaction of expression (25) or (27) allows such a determination that the face of the person is three-dimensionally recognized and thus a three-dimensional effect is provided. On the other hand, satisfaction of expression (26) or (28) allows such a determination that the face is recognized to be plane and thus no three-dimensional effect is provided.

Expression (22) is rewritten for the object distance y1 as shown by following expression (29).

$$\vert 2 \cdot \frac{scw}{ds} \cdot \frac{f}{ccw} \cdot \frac{wc}{δ t} \vert < y 1 \qquad ( 29 )$$

Thus, the object distance y1 at which the planarization occurs can be directly determined.

Furthermore, when a thickness between the head i of the nose of the person located at the close distance and the ear j thereof is represented by Δ, a parallax amount for the thickness Δ is calculated by differentiating the relative parallax amount α-β in expression (14) with the object distance y1 to obtain a sensitivity of the parallax amount to the object distance and by multiplying the obtained sensitivity with the thickness Δ.

Expression (14) is differentiated to obtain following expression (30).

$$\frac{\partial ( α - β )}{\partial y 1} = \frac{2 \cdot scw \cdot wc \cdot f}{ds \cdot ccw \cdot y {1}^{2}} \qquad ( 30 )$$

Multiplying expression (30) with the thickness Δ provides the parallax amount for the thickness Δ.

Determination of an object distance at which no three-dimensional effect is made for the object having the thickness Δ is represented by following expressions (31) and (32).

$$\begin{matrix}\vert \frac{2 \cdot Δ \cdot scw \cdot wc \cdot f}{ds \cdot ccw \cdot y {1}^{2}} \vert \geq δ t & ( 31 ) \\ \vert \frac{2 \cdot Δ \cdot scw \cdot wc \cdot f}{ds \cdot ccw \cdot y {1}^{2}} \vert < δ t & ( 32 )\end{matrix}$$

When expression (31) is satisfied, it is determined that the face of the person is three-dimensionally recognized and thus a three-dimensional effect is provided. When expression (32) is satisfied, it is determined that the face is two-dimensionally recognized and thus no three-dimensional effect is provided.

When a parallax amount of a main object such as a person satisfies expression (26), (28) or (32) and a parallax amount of an object as a background (hereinafter referred to as “a background object”) satisfies expression (19) or (21), the background object has a parallax amount equal to or larger than the lowest allowable parallax value δt and thus is recognized three-dimensionally. On the other hand, the main object has a parallax amount smaller than the lowest allowable parallax value δt and thus is not recognized three-dimensionally. The phenomenon is called a cardboard effect.

Next, description will be made of image capturing performed in such a condition that the background object satisfies expression (20) or (22), in other words, the background object is planarized and that an image capturing magnification is set so that an object looks smaller than its actual size. This image capturing obtains an image in which an object (such as a person or a car) captured smaller than its actual size is recognized three-dimensionally and being surrounded by a plane background. This phenomenon is called a miniascape effect.

The planarization, the cardboard effect and the miniascape effect can be defined as an effect obtained by a brain when both a three-dimensionally recognized image and a two-dimensionally recognized image exist in one image. Therefore, the planarization, the cardboard effect and the miniascape effect are directly associated with a parallax for which a three-dimensional effect is obtained, through the lowest allowable parallax value as an evaluation value. Thus, to display a favorable three-dimensional image without the planarization, the cardboard effect and the miniascape effect, it is desirable to control the image capturing parameters and adjust the observation parameters using the lowest allowable parallax value at image capturing to obtain parallax images and at observation of parallax images.

The display of a good three-dimensional image is hindered by, in addition to the planarization, the cardboard effect and the miniascape effect, a larger relative parallax amount calculated by expression (14) or (15) than a fusional limit under which the observer can fuse the right and left parallax images.

Next, description will be made of the fusional limit. In FIG. 15C, although actual parallax images are displayed on the display surface, the observer recognizes that the object A is at the position y2. That is, the eyes of the observer are in different focus states on the parallax images actually displayed on the display surface and on a three-dimensional image recognized by the observer. In other words, there is a shift between a convergence position of the right and left eyes of the observer (that is, a position toward which the eyes direct in a cross-eyed manner) and a position on which the eyes are focused. When this shift is large, the observer cannot recognize a single three-dimensional image from the right and left parallax images, but recognizes the right and left parallax images as a double image. When an upper limit value of a range of the relative parallax amount for which the observer can fuse the parallax images into a single three-dimensional image is denoted by a fusional limit ξ, this range of the relative parallax amount can be expressed by following expression (33) or (34).

$$\begin{matrix}\vert \frac{Pl - Pr}{ds} - \frac{2 s}{ds} \vert \leq ξ & ( 33 ) \\ \vert \frac{scw}{ds} \cdot \frac{f}{ccw} \cdot \frac{wc}{y 1} - \frac{s}{ds} \vert \leq \frac{ξ}{2} & ( 34 )\end{matrix}$$

A three-dimensional image of an object located nearest to the cameras in the depth direction at image capturing is fused (reproduced) at a position nearest to the observer at observation, and a three-dimensional image of an object located farthest from the cameras in the same direction at image capturing is fused at a position farthest from the observer at observation. Thus, in order that all objects in the parallax images are included in a range (hereinafter referred to as “a fusion allowing range”) equal to or smaller than the fusional limit, it is only necessary that the object located nearest to the cameras and the object located farthest from the cameras be evaluated. When the object located nearest to the cameras (hereinafter referred to as “a nearest object”) is represented by n, the object located farthest from cameras (hereinafter referred to as “a farthest object”) is represented by f and object distances of the nearest object and the farthest object (hereinafter respectively referred to as “a maximum distance and a minimum distance”) are respectively represented by y1n and y1f, a condition that all objects are included in the fusion allowing range is expressed by following expression (35).

$$( \frac{wc \cdot scw \cdot f}{ds \cdot ccw} ) \cdot ( \frac{1}{y {1}_{n}} - \frac{1}{y {1}_{f}} ) \leq ξ \qquad ( 35 )$$

The fusional limit ξ is different between individual observers, but is typically about 2 degrees (absolute value). Furthermore, an absolute value of the relative parallax amount for which the observer can comfortably recognize a three-dimensional image is typically about one degree.

With a relative parallax amount exceeding the fusional limit ξ, the right and left parallax images are recognized as a double image. Therefore, in order to display a good three-dimensional image, the image capturing parameters needs to be controlled and the observation parameters needs to be adjusted also with this fusional limit taken into account.

In each of the embodiments, in order to produce parallax images allowing presentation of a good three-dimensional image to the observer, a determination is made of whether or not the parallax images allow fusion of a three-dimensional image (hereinafter referred to as “three-dimensional image fusion”) by the observer, by using determination-purpose information that is one of the parallax amount between the parallax images and the object distance at image capturing. In addition, a determination is made of the three-dimensional effect by using the determination-purpose information and the lowest allowable parallax value. Then, at least one of the image capturing parameters is controlled depending on a determination result of whether or not the parallax images allow the three-dimensional image fusion and a determination result of the three-dimensional effect.

Hereinafter, description will be made of specific embodiments.

### Embodiment 1

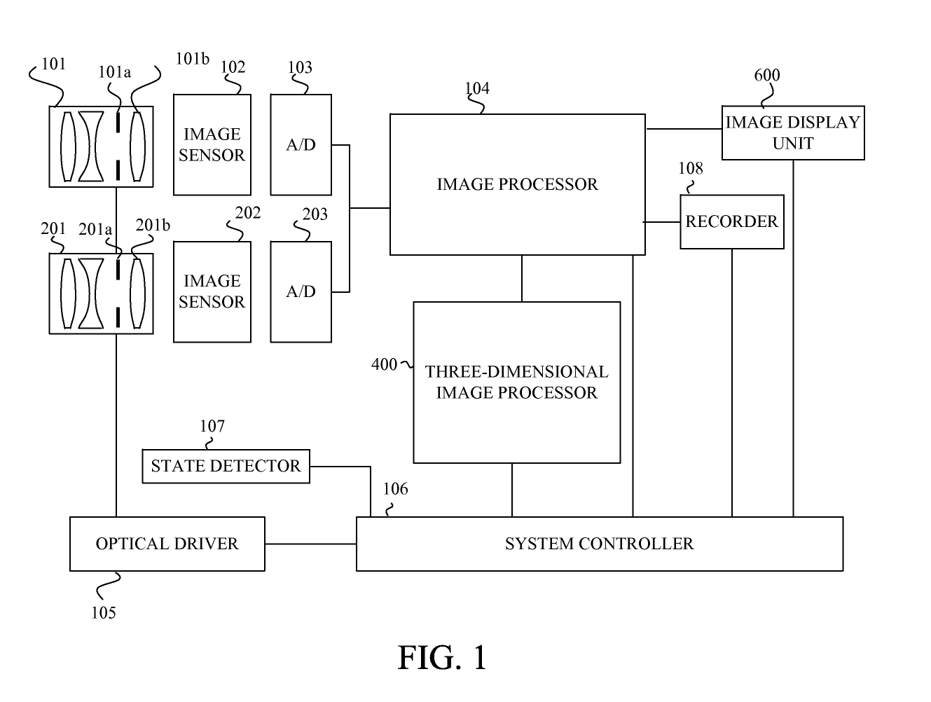

FIG. 1 illustrates a configuration of a three-dimensional image capturing apparatus that is a first embodiment (Embodiment 1) of the present invention. When capturing images of an object by two image capturers 100 and 200 from two right and left viewpoints to produce right and left parallax images, the three-dimensional image capturing apparatus in this embodiment controls the image capturing parameters so that a sufficient three-dimensional effect of the object is provided and the relative parallax amount is included in the fusion allowing range. This control produces the parallax images allowing presentation of a good three-dimensional image from which the observer can feel a sufficient three-dimensional effect.

Reference numeral 101 denotes a right image capturing optical system including an aperture stop 101a and a focus lens 101b. Reference numeral 201 denotes a left image capturing optical system including an aperture stop 201a and a focus lens 201b. A distance between optical axes of the left and right image capturing optical systems 201 and 101, which is the base length, is typically desired to be about 65 mm, but in this embodiment, the base length is changeable. The left and right image capturing optical systems 201 and 101 each include a magnification-varying lens that is movable to change a focal length of each image capturing optical system.

Reference numeral 102 denotes a right image sensor, and reference numeral 202 denotes a left image sensor. The left and right image sensors 202 and 201 convert an object image (optical image) formed through the left and right image capturing optical systems 201 and 101 into electric signals. The image sensors are each a two-dimensional image sensor such as a CCD sensor or CMOS sensor. The right image capturing optical system 101 and the right image sensor 102 are included in the right image capturer 100 (one of two image capturers), and the left image capturing optical system 201 and left image sensor 202 are included in the left image capturer 200 (the other of the two image capturers).

Reference numeral 103 denotes a right A/D converter, and reference numeral 203 denotes a left A/D converter. The left and right A/D converter 203 and 103 convert analog output signals output from the left and right image sensors 202 and 102 into digital signals and supply these digital signals to an image processor 104.

The image processor 104 performs image processes such as a pixel interpolation process and a color conversion process on the digital signals from the left and right A/D converter 203 and 103 to produce right and left parallax images. The image processor 104 also calculates, from at least one of the right and left parallax images, information of an object luminance and focus states (contrast states) of the left and right image capturing optical systems 201 and 101 to supply calculation results to a system controller 106. An operation of the image processor 104 is controlled by the system controller 106.

A three-dimensional image processor 400 receives the right and left parallax images produced by the image processor 104. Then, the three-dimensional image processor 400 calculates the parallax amount between these parallax images to determine the three-dimensional effect obtained from the parallax images and performs a process to determine whether or not the relative parallax amount of the parallax images is included in the fusion allowing range. A specific configuration of the three-dimensional image processor 400 will be described later. A state detector 107 detects an image capturing state such as current values of the image capturing parameters (the base length, the focal length, the image sensor size, the angle of convergence and the object distance). The state detector 107 also detects a current optical state such as aperture diameters of the aperture stops 201a and 101a of the left and right image capturing optical systems 201 and 101 and positions of the focus lenses 201b and 101b. Then, the state detector 107 supplies information on these image capturing state and optical state to the system controller 106.

The system controller 106 controls an optical driver 105 based on the calculation result from the image processor 104 and the information on the optical state from the state detector 107, thereby changing the aperture diameters of the aperture stops 201a and 101a and moving the focus lenses 201b and 101b. This control enables automatic exposure control and autofocus. The system controller 106 may control the optical driver 105 to change the base length and the focal lengths of the left and right image capturers 200 and 100 as the image capturing parameters.

A recorder 108 records the left and right parallax images produced by the image processor 104. An image display unit 600 includes, for example, a liquid crystal display element and a lenticular lens. The image display unit 600 allows observation of a three-dimensional image by an optical effect of the lenticular lens which introduces the left and right parallax images displayed on the liquid crystal display element to the left and right eyes of the observer, respectively.

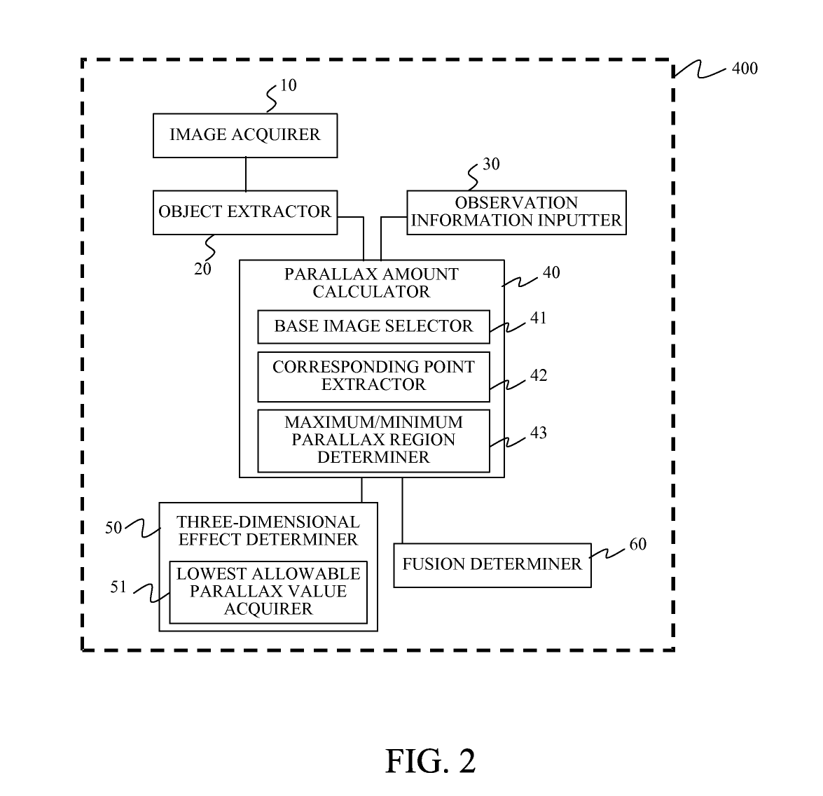

Next, description will be made of a configuration of the three-dimensional image processor 400 with reference to FIG. 2. An image acquirer 10 acquires the left and right parallax images produced by the image processor 104. An object extractor 20 extracts a specific object (main object) in the parallax images. An observation condition inputter 30 acquires an observation condition (the size, the visual distance and the offset amount of the display surface of the image display unit 600) as the observation parameters used to display the parallax images on the image display unit 600 to allow observation of the three-dimensional image by the observer.

A parallax amount calculator 40 includes a base image selector 41, a corresponding point extractor 42 and a maximum/minimum parallax region determiner 43. The base image selector 41 selects one of the left and right parallax images as a parallax amount calculation base image for calculating the parallax amount and selects the other parallax image as a parallax amount calculation reference image.

The corresponding point extractor 42 extracts multiple pairs of corresponding points as pixels corresponding to each other between the left and right parallax images. The corresponding points are pixels in the left and right parallax images that capture images of an identical object. The parallax amount calculator 40 calculates the parallax amounts at the multiple pairs of corresponding points extracted by the corresponding point extractor 42, in other words, calculates the parallax amount of each of multiple pairs of corresponding objects. The maximum/minimum parallax region determiner 43 determines a maximum parallax region and a minimum parallax region that are image regions respectively having a maximum value (maximum parallax amount) and a minimum value (minimum parallax amount) of the calculated parallax amounts. The object extractor 20 and the corresponding point extractor 42 each correspond to an extractor.

A fusion determiner 60 determines whether or not the relative parallax amount of the maximum parallax region and the minimum parallax region determined by the maximum/minimum parallax region determiner 43 are included in the fusion allowing range under the observation condition acquired from the observation information inputter 30. The parallax amount calculator 40 and the fusion determiner 60 constitute a first determiner. The determination performed by the fusion determiner 60 is hereinafter referred to as “a fusion possibility determination”.

A three-dimensional effect determiner 50 includes a lowest allowable parallax value acquirer 51. The lowest allowable parallax value acquirer 51 acquires the above-mentioned lowest allowable parallax value. The three-dimensional effect determiner 50 determines, by using this lowest allowable parallax value, whether or not a three-dimensional effect of a specific object in the parallax images is provided. The parallax amount calculator 40 and the three-dimensional effect determiner 50 constitute a second determiner. The determination performed by the three-dimensional effect determiner 50 is hereinafter referred to as “a three-dimensional effect determination”.

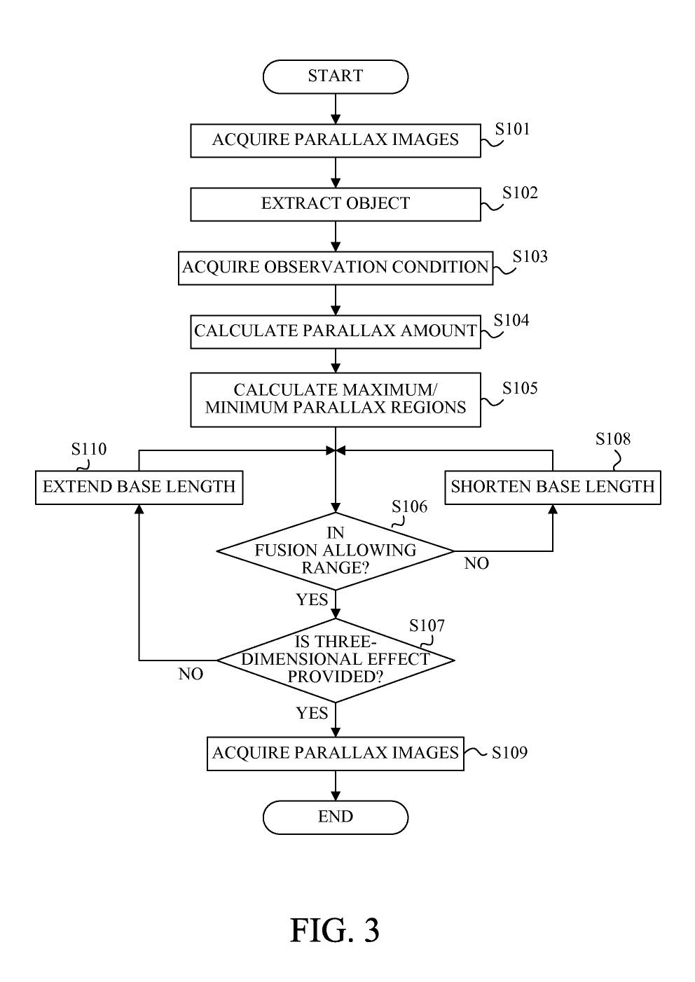

Next, description will be made of processing performed by the system controller 106 and the three-dimensional image processor 400 in the three-dimensional image capturing apparatus of this embodiment with reference to a flowchart shown in FIG. 3. The system controller (controller) 106 as a control computer and the three-dimensional image processor 400 as an image processing computer perform the following processes (operations) according to a three-dimensional image capturing program as a computer program. The three-dimensional image capturing program can be supplied via a non-transitory computer-readable storage medium such as a semiconductor memory or an optical disc (a DVD or a CD). This applies to other embodiments described later.

First, at step S101, in response to detection of an operation by a user (photographer) to instruct start of image capturing preparation, the system controller 106 controls the left and right image capturing optical systems 201 and 101 through the optical driver 105 based on selection or setting by the user. The system controller 106 also causes the left and right image sensors 202 and 102 to photoelectrically convert object images respectively formed by the left and right image capturing optical systems 201 and 101. Then, the system controller 106 transfers outputs from the left and right image sensors 202 and 102 to the image processor 104 through the A/D converters 203 and 103 and causes the image processor 104 to produce left and right parallax images. The three-dimensional image processor 400 (image acquirer 10) acquires the left and right parallax images produced by the image processor 104.

Next, at step S102, the three-dimensional image processor 400 (object extractor 20) extracts (selects) a specific object from the parallax images. The object extractor 20 extracts the specific object in an object region specified through, for example, an input interface, such as a touch panel or a button, operable by the user based on a feature amount such as color and information on edges. The object extractor 20 can also extract a person as a main object by using a well-known face recognition technique. Additionally, the object extractor 20 may use a template matching method which registers, as an object extraction base image (template image), a partial image region arbitrarily extracted from one of the partial image and extracts, from the other of the parallax images, an image region having a highest correlation with the template image. The template image may be registered by the user at image capturing or may be selected by the user from among multiple types of typical template images previously recorded in a memory. In this example, the person enclosed by solid lines in FIG. 16 is extracted as the specific object (main object).

Next, at step S103, the three-dimensional image processor 400 (observation condition inputter 30) acquires the observation condition, which is information such as the size and the visual distance of the display surface, from the image display unit 600 through the system controller 106. The observation condition may include information of the number of display pixels. Information of the observation condition may be acquired through inputting by the user through the input interface or may be selected by the user from among typical possible observation conditions that are previously registered. Steps S101 to S103 described so far may be performed in different orders.

Next, at step S104, the three-dimensional image processor 400 (parallax amount calculator 40) calculates the parallax amount of the specific object extracted at step S102. The parallax amount calculator 40 first causes the base image selector 41 to select one of the left and right parallax images as the parallax amount calculation base image, and the other as the parallax amount calculation reference image. Next, the parallax amount calculator 40 causes the corresponding point extractor 42 to extract, as described above, the multiple pairs of corresponding points from multiple positions in the parallax amount calculation base and reference images.

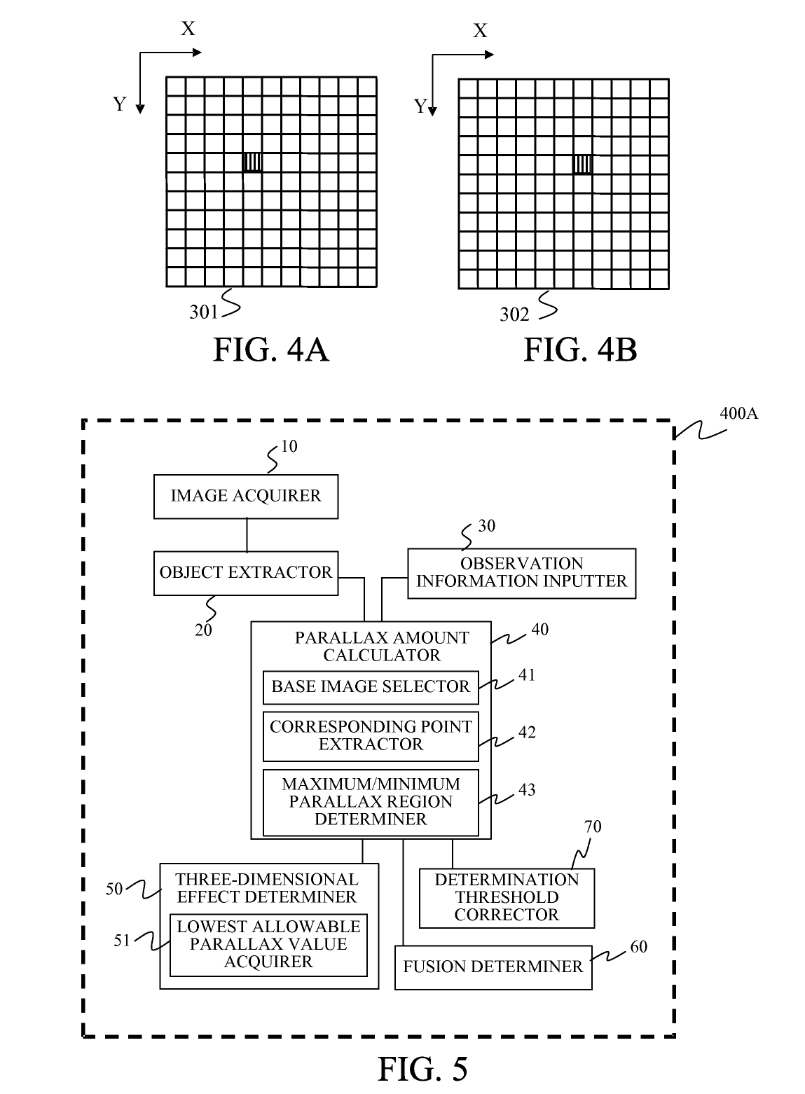

Description will be made of a method of extracting the corresponding points with reference to FIG. 4A and FIG. 4B. The method sets an XY coordinate system in each parallax image. This coordinate system defines an upper-left pixel in each of a parallax amount calculation base image 301 on a left side in FIG. 4A and a parallax amount calculation reference image 302 on a right side in FIG. 4B as an origin. Furthermore, an X-axis (X-direction) is set in a horizontal direction in FIG. 4A and FIG. 4B, and a Y-axis (Y-direction) is set in a vertical direction therein. F1(X,Y) represents a luminance at a pixel (X,Y) in the base image 301, and F2(X,Y) represents a luminance at a pixel (X,Y) in the reference image 302.

A pixel (hatched in FIG. 4B) in the reference image 302 corresponding to an arbitrary pixel (X,Y) (hatched) in the base image 301 in FIG. 4A has a luminance most similar to the luminance F1(X,Y) in the base image 301. However, it is difficult in reality to search for a most similar pixel to an arbitrary pixel, so that the most similar pixel is searched for with a method called “block matching” by using pixels neighboring the pixel (X,Y).

Description will be made of a process to perform the matching when a block size is, for example, three. Three pixels of one arbitrary pixel (X,Y) in the base image 301 and two neighboring pixels (X−1,Y) and (X+1,Y) have luminance values below:

F1(X,Y);

F1(X−1,Y); and

F1(X+1,Y).

On the other hand, a pixel in the reference image 302 shifted from the pixel (X,Y) by k pixels in the X direction and its two neighboring pixels have luminance values below:

F2(X+k,Y);

F2(X+k−1,Y); and

F2(X+k+1,Y)

In this case, a degree of similarity E to the pixel (X,Y) in the base image 301 is defined by following expression (36).

$$E = [ F 1 ( X , Y ) - F 2 ( X + k , Y ) ] + [ F 1 ( X - 1 , Y ) - F 2 ( X + k - 1 , Y ) ] + [ F 1 ( X + 1 , Y ) - F 2 ( X + k + 1 , Y ) ] = {\sum }_{j = - 1}^{1} [ F 1 ( X + j , Y ) - F 2 ( X + k + j , Y ) ] \qquad ( 36 )$$

With this expression (36), the degree of similarity E is calculated for different k values. Then, a pixel (X+k,Y) in the reference image 302 having a smallest degree of similarity E in the reference image 302 is the corresponding point to the pixel (X,Y) in the base image 301.

Instead of the above-described block matching, another method such as edge extraction may be used to extract the corresponding points.

Next, the parallax amount calculator 40 calculates the parallax amount (Pl-Pr) between each of the multiple pairs of corresponding points (correspondence objects) extracted at the multiple positions. Specifically, the parallax amount calculator 40 first calculates the image capturing parallax amount differences Plc and Prc at coordinates of each pair of the corresponding points using expressions (1) and (2) described above. Next, the parallax amount calculator 40 calculates the display magnification m and then calculates the left and right display parallax amounts Pl and Pr from expressions (3) and (4) to calculate the parallax amount (Pl-Pr).

Next, at step S105, the three-dimensional image processor 400 (maximum/minimum parallax region determiner 43) determines, as the maximum parallax region, an image region that is part of each parallax image and includes one of the paired corresponding points having the maximum parallax amount of the parallax amounts between the multiple pairs of corresponding points calculated at step S104. The three-dimensional image processor 400 also determines, as the minimum parallax region, an image region that is part of each parallax image and includes one of the paired corresponding points having the minimum parallax amount of the parallax amounts between the multiple pairs of corresponding points. Expression (14) shows that a large absolute value of the parallax amount (Pl-Pr) leads to a large relative parallax amount at observation, so that the maximum and minimum parallax regions at which the parallax amounts (Pl-Pr) are maximum and minimum are acquired. When both the parallax amounts of these maximum and minimum parallax regions are equal to or smaller than the fusional limit, in other words, when the maximum and minimum parallax regions are included in the fusion allowing range, other image regions in the parallax images are always included in the fusion allowing range. As described above, in this embodiment, performing the fusion possibility determination only for the image regions having the maximum and minimum parallax amounts determines whether the entire left and right parallax images (in other words, all objects in the parallax images) are allowed to be fused into a three-dimensional image by the observer. This can reduce a processing load as compared to a case of performing the fusion possibility determination for all image regions in the parallax images.

Next, at step S106 as a fusion possibility determination step, the three-dimensional image processor 400 (fusion determiner 60) determines whether or not the maximum and minimum parallax regions in the left and right parallax images acquired at step S103 are included in the fusion allowing range under the observation condition. In other words, the fusion determiner 60 performs the fusion possibility determination. Specifically, the fusion determiner 60 determines whether or not expression (33) is satisfied by using the fusional limit ξ, the parallax amounts (maximum and minimum parallax amounts) of the maximum and minimum parallax regions determined at step S105 and the observation condition acquired at step S103. If expression (33) is satisfied for both the maximum and minimum parallax amounts, in other words, both the maximum and minimum parallax regions are included in the fusion allowing range, the three-dimensional image processor 400 proceeds to step S107. On the other hand, if expression (33) is not satisfied for at least one of the maximum and minimum parallax amounts, in other words, at least one of the maximum and minimum parallax regions is not included in the fusion allowing range, the three-dimensional image processor 400 proceeds to step S108.

At step S108, the system controller 106 performs a control to shorten the base length to reduce a relative parallax amount (absolute value) as a difference between the maximum and minimum parallax amounts so that both the maximum and minimum parallax regions are included in the fusion allowing range. Expression (14) can be written as below by using expressions (7) and (8).

$$\vert α - β \vert = \vert \frac{2 m \cdot f}{ds \cdot y 1} \cdot wc - \frac{2 s}{ds} \vert \qquad ( 37 )$$

This expression shows that a longer base length we provides a larger absolute value of the relative parallax amount, and in other words, a shorter base length wc provides a smaller absolute value of the relative parallax amount. For this reason, the system controller 106 controls the optical driver 105 to shorten the base length wc of the left and right image capturing optical systems 201 and 101, which is one of the image capturing parameters, by a predetermined amount. After the base length is thus shortened, the fusion determiner 60 performs again the fusion possibility determination at step S106. When at least one of the maximum and minimum parallax regions is not included in the fusion allowing range, the system controller 106 shortens again the base length by the predetermined amount at step S108. In this manner, after such an adjustment (reduction) of the base length is performed until the maximum and minimum parallax regions are included in the fusion allowing range, the three-dimensional image processor 400 proceeds to step S107.

At step S107 as a three-dimensional effect determination step, the three-dimensional image processor 400 (three-dimensional effect determiner 50) determines whether or not a three-dimensional effect of the specific object is provided, by using the parallax amount calculated at step S104 and the lowest allowable parallax value δt. In other words, the three-dimensional effect determiner 50 performs the three-dimensional effect determination. Specifically, the three-dimensional effect determiner 50 first causes the lowest allowable parallax value acquirer 51 to acquire the lowest allowable parallax value δt. The lowest allowable parallax value δt is, as described above, a parallax amount (for example, three arcminutes) for which most observers have no three-dimensional effect.

Next, the three-dimensional effect determiner 50 selects an evaluation point in the specific object at which three-dimensional effect is evaluated. For example, the head of the nose of the person illustrated in FIG. 16 is selected as an evaluation point i, and each of the ears thereof is selected as an evaluation point j. Methods of selecting the evaluation points include a method of selecting part of objects in the image region having the maximum or minimum parallax amount of the parallax amounts calculated at step S104 and a method of selecting the evaluation points through the input interface described above by the user.

Next, the three-dimensional effect determiner 50 determines whether or not expression (25) is satisfied by using the lowest allowable parallax value δt, the parallax amount of the selected evaluation point and the visual distance which is one of the observation conditions acquired at step S103. If expression (25) is satisfied, the observer can feel the three-dimensional effect of the specific object including the evaluation points i and j, and thus the three-dimensional effect determiner 50 determines that three-dimensional effect of the specific object is provided. On the other hand, if expression (25) is not satisfied, since the observer cannot feel the three-dimensional effect of the specific object, the three-dimensional effect determiner 50 determines that the three-dimensional effect of the specific object is not provided.

In this embodiment, the three-dimensional effect determination is performed by using expression (25) at step S107. However, since the lowest allowable parallax value δt is a statistic by a subjective evaluation, results of the three-dimensional effect determination may have a slight difference depending on observers. Thus, as indicated in expression (38) below, the three-dimensional effect determination may be performed by correcting (changing) the lowest allowable parallax value δt as a determination threshold with a correction value C depending on the difference in three-dimensional effect between individual observers.

$$\vert \frac{( {Pl}_{i} - {Pr}_{i} ) - ( {Pl}_{j} - {Pr}_{j} )}{ds} \vert \geq C \cdot δ t \qquad ( 38 )$$

The correction value C may be a value recorded as an initial condition in a memory (not illustrated) or may be input by the user through the input interface described above.

When it is determined at step S107 that the three-dimensional effect of the object is not provided, the system controller 106 proceeds to step S110 to increase the three-dimensional effect of the object. At step S110, the system controller 106 controls the optical driver 105 to extend the base length wc of the left and right image capturing optical systems 201 and 101 by the predetermined amount. This is because expression (23) shows that three-dimensional effect of the object increases as the base length wc of the left and right image capturing optical systems 201 and 101 increases.

However, the extension of the base length increases the parallax amounts of the maximum and minimum parallax regions determined by the maximum/minimum parallax region determiner 43, so that the maximum and minimum parallax regions may be out of the fusion allowing range. Thus, again at step S106, the fusion determiner 60 performs the fusion possibility determination for the maximum and minimum parallax regions. If it is determined that the maximum and minimum parallax regions are out of the fusion allowing range, the system controller 106 shortens, at step S108, the base length by an amount smaller than the predetermined amount by which the base length is extended at step S107. Then, again at steps S106 and S107, the fusion determiner 60 and the three-dimensional effect determiner 50 perform again the fusion possibility determination and the three-dimensional effect determination, respectively. In this manner, steps S106 to S108 and S110 are repeated until all the objects are included in the fusion allowing range and the three-dimensional effect of the specific object is determined to be provided.

When the maximum and minimum parallax regions are determined to be out of the fusion allowing range at step S106 after the base length is extended at step S110, a value of the base length when the maximum and minimum parallax regions are out of the fusion allowing range may be recorded in a memory (not illustrated), and the base length may be controlled again to be equal to or smaller than the recorded value. This can efficiently control the base length.

On the other hand, when it is determined at step S107 that the three-dimensional effect of the specific object is provided, it is already determined at step S106 that all the objects are included in the fusion allowing range. Thus, image capturing in this state can produce the left and right parallax images allowing the three-dimensional image fusion of all the objects by the observer (that is, preventing the observer from recognizing them as a double image) and can obtain a sufficient three-dimensional effect of the specific object. Accordingly, at step S109, the system controller 106 performs image capturing similarly to that in step S101 to acquire such left and right parallax images and displays these parallax images on the image display unit 600 or records them in the recorder 108. When it is determined that the maximum and minimum parallax regions (all the objects) in the parallax images acquired at step S101 are included in the fusion allowing range and the three-dimensionally effect of the specific object is provided, the parallax images acquired at step S101 may be displayed or recorded without any correction.

As described above, this embodiment can easily produce the parallax images providing a sufficient three-dimensional effect of the specific object and allowing the three-dimensional image fusion of each object by the observer, by controlling the image capturing parameters depending on the results of the fusion possibility determination and the three-dimensional effect determination.

This embodiment has described the case of adjusting the three-dimensional effect by changing the base length of the right and left image capturing optical systems depending on the results of the fusion possibility determination and the three-dimensional effect determination. However, in addition to or in place of the base length, the focal length of the right and left image capturing optical systems as one of the image capturing parameters may be changed.

Furthermore, this embodiment has described the case of performing the image capturing by the parallel method in which the optical axes of the right and left image capturing optical systems are disposed mutually parallel. However, the same process as that in this embodiment can be performed to obtain a good three-dimensional image in a case of performing image capturing by the intersection method in which the optical axes of the right and left image capturing optical systems intersect with each other. In the intersection method, changing the angle (angle of convergence) between the optical axes of the right and left image capturing optical systems as one of the image capturing parameters changes the relative parallax amount, thereby adjusting a fusion possibility of the three-dimensional image and the three-dimensional effect thereof.

This embodiment has described the case of performing the three-dimensional effect determination after the fusion possibility determination, but these determinations may be performed in a different order.

These configurations about the change of the focal lengths, the change of the angle of convergence in the intersection method and a determination order are the same in the other embodiments described later.

### Embodiment 2

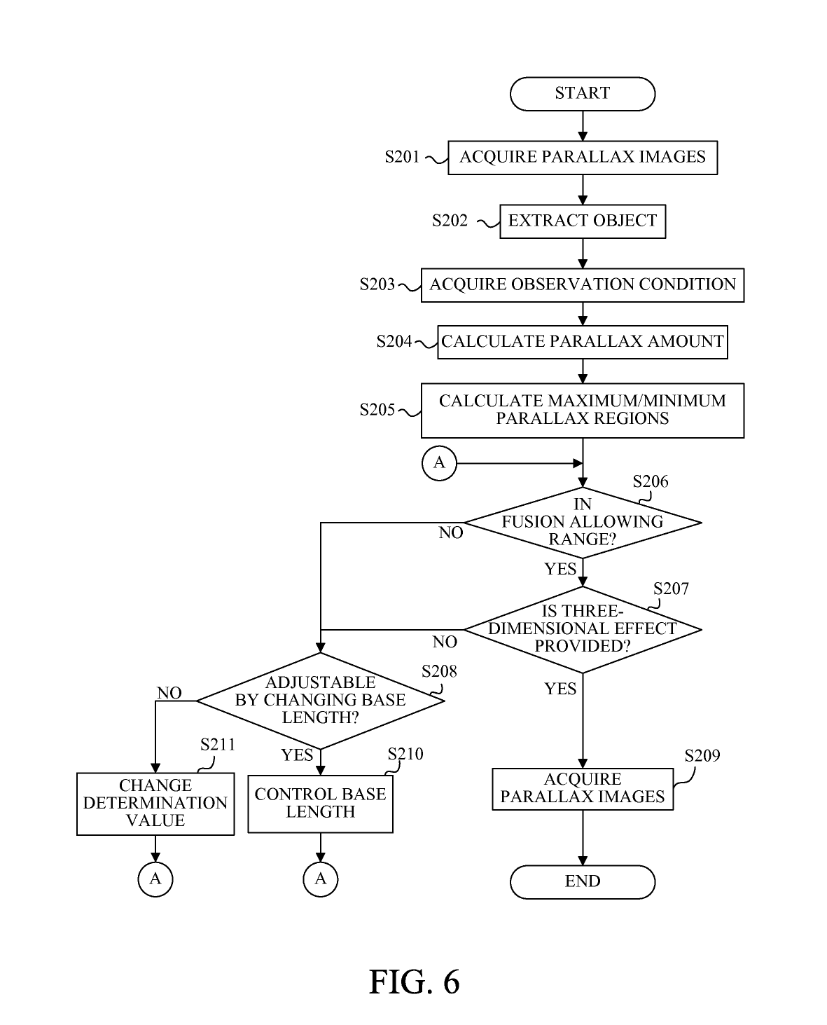

Next, description will be made of a three-dimensional image capturing apparatus that is a second embodiment (Embodiment 2) of the present invention with reference to FIG. 5. The three-dimensional image capturing apparatus of this embodiment has the same whole configuration as that of the three-dimensional image capturing apparatus of Embodiment 1, and components common to those in Embodiment 1 are denoted by the same reference numerals as those in Embodiment 1. In this embodiment, a three-dimensional image processor 400A has a different configuration from that of the three-dimensional image processor 400 in Embodiment 1. Specifically, the three-dimensional image processor 400A has a configuration including a determination threshold corrector 70 added to the three-dimensional image processor 400. The determination threshold corrector 70 changes (corrects), as necessary and in an allowable range, at least one of the fusional limit ξ as a determination threshold used for the fusion possibility determination and the lowest allowable parallax value δt as a determination threshold used for the three-dimensional effect determination.

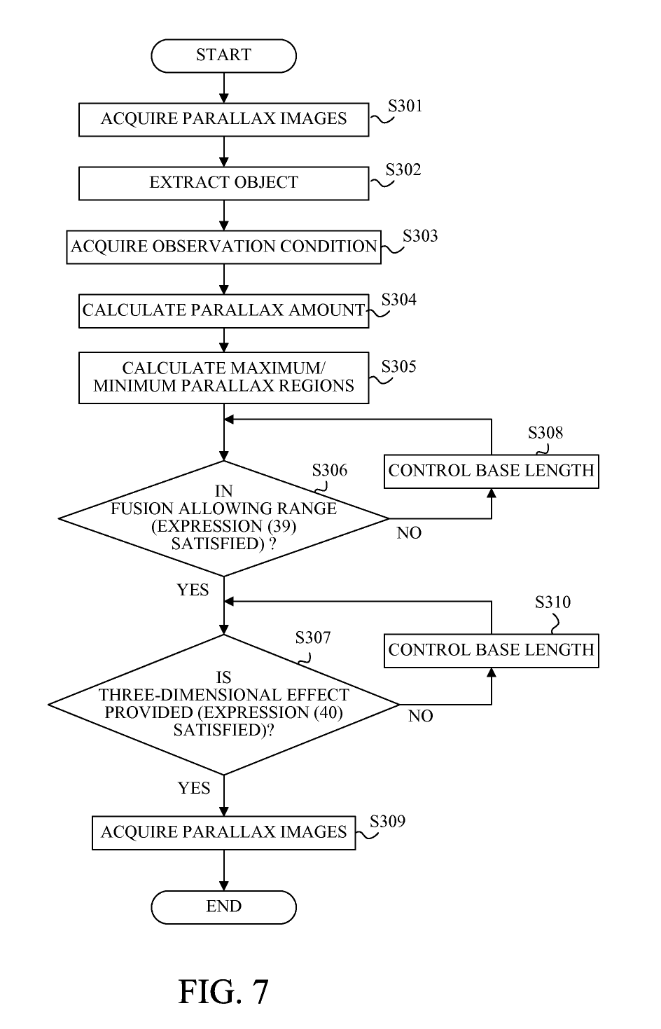

Description will be made of processes performed by the system controller 106 and the three-dimensional image processor 400A in the three-dimensional image capturing apparatus of this embodiment with reference to a flowchart shown in FIG. 6. Similarly to Embodiment 1, the system controller 106 and the three-dimensional image processor 400A performs the following processes (operations) according to a three-dimensional image capturing program as a computer program.

Steps S201 to S207 are the same as steps S101 to S107 described in Embodiment 1, and description thereof will be omitted. In this embodiment, when at least one of the maximum and minimum parallax regions is determined in the fusion possibility determination at step S206 to be out of the fusion allowing range and when it is determined in the three-dimensional effect determination at step S207 that the three-dimensional effect of the specific object is not provided, a determination at step S208 is performed. When it is determined at step S207 that the three-dimensional effect is provided, the system controller 106 proceeds to step S209 to perform image capturing to acquire the left and right parallax images as at step S109 in Embodiment 1.

At step S208, the system controller 106 determines whether or not an adjustment is possible by only changing (controlling) the base length of the left and right image capturing optical systems 201 and 101 so that both the maximum and minimum parallax regions are included in the fusion allowing range and the three-dimensional effect of the specific object is provided. If the adjustment is possible, the system controller 106 proceeds to step S210 to control the base length through the optical driver 105. Specifically, the system controller 106 performs a control to shorten the base length so that both the maximum and minimum parallax regions are included in the fusion allowing range and performs a control to extend the base length to increase the three-dimensional effect of the specific object. After the base length is changed, the fusion determiner 60 performs the fusion possibility determination again at step S206, and the three-dimensional effect determiner 50 performs the three-dimensional effect determination at step S207.

On the other hand, when the adjustment is not possible at step S208, the three-dimensional image processor 400A (determination threshold corrector 70) corrects the determination threshold (at least one of the fusional limit ξ and the lowest allowable parallax value δt) at step S211. Description will hereinafter be made of a case of correcting the fusional limit ξ.

Although the fusional limit ξ is typically about 2 degrees as described above, a larger fusional limit value may be used without any problem by performing a special image process on the parallax images to be displayed. For example, performing an image process that adds blur to an image region of each of the parallax images having a strongest three-dimensional effect can increase the fusional limit ξ that is allowable. The fusional limit ξ thus changed may be acquired from the user through the input interface described in Embodiment 1 or may be acquired from possible values previously recorded in the memory.

The determination threshold corrector 70 replaces a current fusional limit ξ with a new fusional limit thus acquired. The determination threshold corrector 70 may correct the lowest allowable parallax value δt in a similar manner.

Thereafter, at step S206, the three-dimensional image processor 400A (fusion determiner 60) performs the fusion possibility determination by using the corrected fusional limit ξ. Then, at step S207, the three-dimensional image processor 400A (three-dimensional effect determiner 50) performs the three-dimensional effect determination using the lowest allowable parallax value (or a corrected lowest allowable parallax value when corrected) δt.

As described above, this embodiment also can easily produce the parallax images providing a sufficient three-dimensional effect of the specific object and allowing the three-dimensional image fusion of each object by the observer, by controlling the image capturing parameters depending on the results of the fusion possibility determination and the three-dimensional effect determination. In addition, this embodiment allows changing the determination threshold for at least one of the fusion possibility determination and the three-dimensional effect determination depending on the image process performed on the parallax images. Therefore, this embodiment can more appropriately perform the determinations, and thereby increasing a width of allowable image capturing conditions.

### Embodiment 3

Next, description will be made of a three-dimensional image capturing apparatus that is a this embodiment (Embodiment 3) of the present invention. The three-dimensional image capturing apparatus of this embodiment has the same whole configuration as that of the three-dimensional image capturing apparatus of Embodiment 1, and components common to those in Embodiment 1 are denoted by the same reference numerals as those in Embodiment 1. However, though not illustrated, this embodiment includes a three-dimensional image processor 400B (a fusion determiner 60′, a three-dimensional effect determiner 50′ and a system controller 106′) different from the three-dimensional image processor 400 in Embodiment 1.

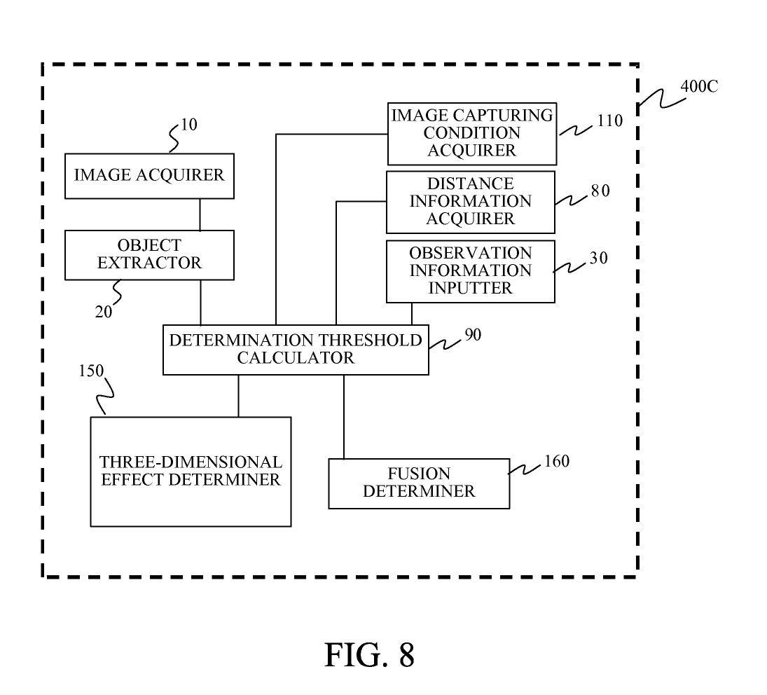

Description will be made of processes performed by the system controller 106′ and the three-dimensional image processor 400B in the three-dimensional image capturing apparatus of this embodiment with reference to a flowchart shown in FIG. 7. Similarly to Embodiment 1, the system controller 106′ and the three-dimensional image processor 400B perform the following processes (operations) according to a three-dimensional image capturing program as a computer program.

Steps S301 to S305 are the same as steps S101 to S105 described in Embodiment 1, and description thereof will be omitted.

After the maximum and minimum parallax regions are determined at step S305, a process at step S306 is performed. At step S306 as a fusion possibility determination step, the three-dimensional image processor 400B (fusion determiner 60′) determines whether or not both the maximum and minimum parallax regions are included in the fusion allowing range under the observation condition acquired at step S303. In other words, fusion determiner 60′ performs the fusion possibility determination.

When the value on the left-hand side of expression (33) described above is equal to the fusional limit ξ on a right-hand side thereof, that is, following expression (39) is satisfied:

$$\vert \frac{Pl - Pr}{ds} - \frac{2 s}{ds} \vert = ξ , \qquad ( 39 )$$

the parallax amounts of the maximum and minimum parallax regions are equal to the fusional limit ξ. The fusion determiner 60′ determines whether or not expression (39) is satisfied by using the fusional limit ξ, the parallax amounts (maximum and minimum parallax amounts) of the maximum and minimum parallax regions determined at step S305 and the observation conditions acquired at step S303.

When expression (39) is satisfied, the maximum and minimum parallax regions are on a limit at which the parallax amounts thereof can be determined to be included in the fusion allowing range. Thus, since extending the base length of the left and right image capturing optical systems 201 and 101 beyond a current base length for which expression (39) is satisfied would cause the maximum and minimum parallax regions to be out of the fusion allowing range, the base length needs to be set to be equal to or smaller than the current base length. In this manner, the fusion determiner 60′ first calculates a maximum value of the base length at this step.

If expression (39) is satisfied at step S306, a process at step S307 is performed. If expression (39) is not satisfied at step S306, the parallax amounts of the maximum and minimum parallax regions are smaller than or larger than the fusional limit ξ, and thus a process at step S308 is performed. In the determination at step S306, the value on the left-hand side of expression (39) does not necessarily need to be completely equal to the fusional limit ξ. In other words, when the value on the left-hand side is included in a predetermined range (for example, a range of ±1.2 times of the fusional limit ξ) including the fusional limit ξ, the value on the left-hand side may be regarded as being equal to the fusional limit ξ.

At step S308, the system controller 106′ controls the base length of the left and right image capturing optical systems 201 and 101. In this control, the system controller 106′ controls the base length respectively depending on a result of the determination at step 306 that the parallax amounts of the maximum and minimum parallax regions are smaller than the fusional limit ξ and a result thereof that the maximum and minimum parallax regions are larger than the fusional limit ξ. When the determination result shows that the parallax amounts of the maximum and minimum parallax regions are smaller than the fusional limit ξ, these parallax amounts need to be increased, and thus the system controller 106′ performs a control to extend the base length. On the other hand, when the determination result shows that the parallax amounts of the maximum and minimum parallax regions are larger than the fusional limit ξ, these parallax amounts need to be reduced, and thus the system controller 106′ performs a control to shorten the base length.

Thereafter, the three-dimensional image processor 400B (fusion determiner 60′) performs the fusion possibility determination again at step S306. When expression (39) is still not satisfied, the system controller 106′ performs the control of the base length again at step S308 and repeats steps S306 and S308 until expression (39) is satisfied.

At step S307 as a three-dimensional effect determination step, the three-dimensional image processor 400B (three-dimensional effect determiner 50′) determines whether or not the three-dimensional effects are provided at the evaluation points i and j (refer to FIG. 16) of the specific object by using the parallax amounts calculated at step S304 and the lowest allowable parallax value δt. In other words, the three-dimensional effect determiner 50′ performs the three-dimensional effect determination.

When the value on the left-hand side of expression (25) described above is equal to a value on the right-hand side thereof, that is, following expression (40) is satisfied:

$$\vert \frac{( {Pl}_{i} - {Pr}_{i} ) - ( {Pl}_{j} - {Pr}_{j} )}{ds} \vert = δ t , \qquad ( 40 )$$

the parallax amount of the specific object including the evaluation points i and j is equal to the lowest allowable parallax value δt. The three-dimensional effect determiner 50′ determines whether or not expression (40) is satisfied by using the lowest allowable parallax value δt, the parallax amount of the specific object and the visual distance as one of the observation conditions acquired at step S303. If expression (40) is satisfied, the parallax amount of the specific object is on a limit allowing the observer to feel the three-dimensional effect of the specific object. In this manner, the three-dimensional effect determiner 50′ provides a parallax amount allowing the observer to recognize a three-dimensional image of the specific object while keeping the left and right parallax images in the fusion allowing range.

On the other hand, if expression (40) is not satisfied, the parallax amount of the specific object is larger than or smaller than the lowest allowable parallax value δt, and thus a process at step S310 is performed. In the determination at step S307, a value on the left-hand side of expression (40) does not necessarily need to be completely equal to the lowest allowable parallax value δt. In other words, when the value on the left-hand side is included in a predetermined range (for example, a range of ±1.2 times of the lowest allowable parallax value δt) including the lowest allowable parallax value δt, the value on the left-hand side may be regarded as being equal to the lowest allowable parallax value δt.

At step S310, the system controller 106′ controls the base length of the left and right image capturing optical systems 201 and 101. In this control, the system controller 106′ controls the base length respectively depending on a result of the determination at step 307 that the parallax amount of the specific object is larger than the lowest allowable parallax value δt and a result thereof that the parallax amount of the specific object is smaller than the lowest allowable parallax value δt. When the determination result shows that the parallax amount of the specific object is larger than the lowest allowable parallax value δt, the parallax amount needs to be reduced, and thus the system controller 106′ performs a control to shorten the base length. On the other hand, when the determination result shows that parallax amount of the specific object is smaller than the lowest allowable parallax value δt, the parallax amount needs to be increased, and thus the system controller 106′ performs a control to extend the base length.

Thereafter, the three-dimensional image processor 400B (three-dimensional effect determiner 50′) performs the three-dimensional effect determination again at step S307. When expression (40) is still not satisfied, the system controller 106′ controls the base length again at step S310 and repeats steps S307 and S310 until expression (40) is satisfied.

When it is determined at step S307 that the three-dimensional effect is provided, the system controller 106′ proceeds to step S309 to perform image capturing to acquire the left and right parallax images similarly to step S109 in Embodiment 1.

As described above, this embodiment also can easily produce the parallax images providing a sufficient three-dimensional effect of the specific object and allowing the three-dimensional image fusion of each object by the observer, by controlling the image capturing parameters depending on the results of the fusion possibility determination and the three-dimensional effect determination.

### Embodiment 4

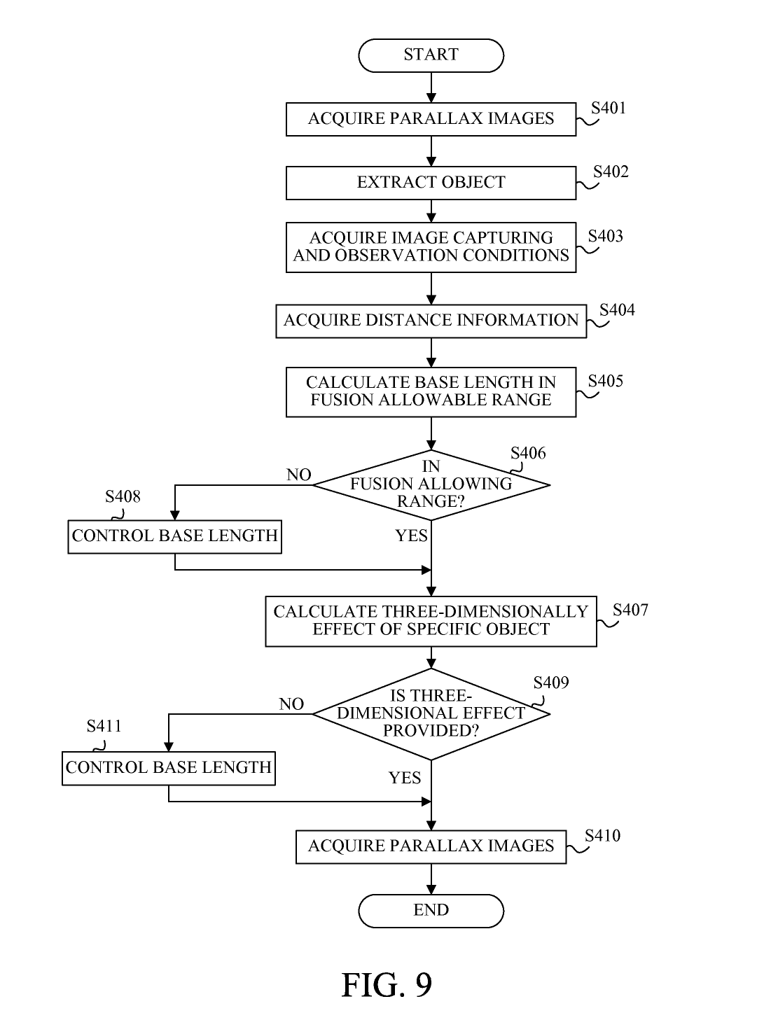

FIG. 8 illustrates a configuration of a three-dimensional image processor 400C in a three-dimensional image capturing apparatus that is a fourth embodiment (Embodiment 4). The three-dimensional image capturing apparatus of this embodiment has the same whole configuration as that of the three-dimensional image capturing apparatus of Embodiment 1, and components common to those in Embodiment 1 are denoted by the same reference numerals as those in Embodiment 1.

The image acquirer 10, the object extractor 20 and the observation condition inputter 30 of the three-dimensional image processor 400C that are common to the three-dimensional image processor 400 of Embodiment 1 are denoted by the same reference numerals as those in Embodiment 1, and description thereof will be omitted. However, the object extractor 20 in this embodiment extracts not only the specific object as in Embodiment 1 but also other objects included in the left and right parallax images. In other words, the object extractor 20 extracts multiple objects included in the left and right parallax images.

A distance information acquirer 80 acquires information on distances (object distances) to the respective objects extracted by the object extractor 20 at image capturing. A method of acquiring the information on the object distance by the distance information acquirer 80 is not particularly limited. The object distance may be obtained, for example, through triangulation by projecting an auxiliary light from a light projector (not illustrated) to the object and receiving a reflected light from the object by a light-receiver (not illustrated). Alternatively, the object distance may be measured by using an ultrasonic sensor from a time (propagation speed) taken by an ultrasonic wave emitted toward the object to come back after being reflected by the object. Still alternatively, in place of these active ranging methods, a passive ranging method may be employed which divides a light flux from the object, receives the divided light fluxes by a line sensor to produce paired image signals and calculates the object distance from a phase difference between the paired image signals. Furthermore, a combination of the passive and active ranging methods may be used. The information on the object distance acquired by the distance information acquirer 80 is used for the fusion possibility determination and the three-dimensional effect determination.

An image capturing condition acquirer 110 acquires, through the state detector 107 and the system controller 106 described in Embodiment 1 (FIG. 1), image capturing conditions as the image capturing parameters (the base length, the focal length, the image sensor size and the angle of convergence) at image capturing. However, the image capturing conditions do not include the object distance acquired by the distance information acquirer 80.

A determination threshold calculator 90 calculates determination thresholds (described later) used by a fusion determiner 160 and a three-dimensional effect determiner 150 in the fusion possibility determination and the three-dimensional effect determination, respectively.

The three-dimensional effect determiner 150 includes the lowest allowable parallax value acquirer 51 described in Embodiment 1. The lowest allowable parallax value acquirer 51 acquires the lowest allowable parallax value δt and determines, by using this lowest allowable parallax value δt, whether or not the three-dimensional effect of the specific object included in the left and right parallax images is provided. The fusion determiner 160 determines whether or not the entire left and right parallax images are included in the fusion allowing range for the observer under the observation conditions acquired from the observation condition acquirer 30.

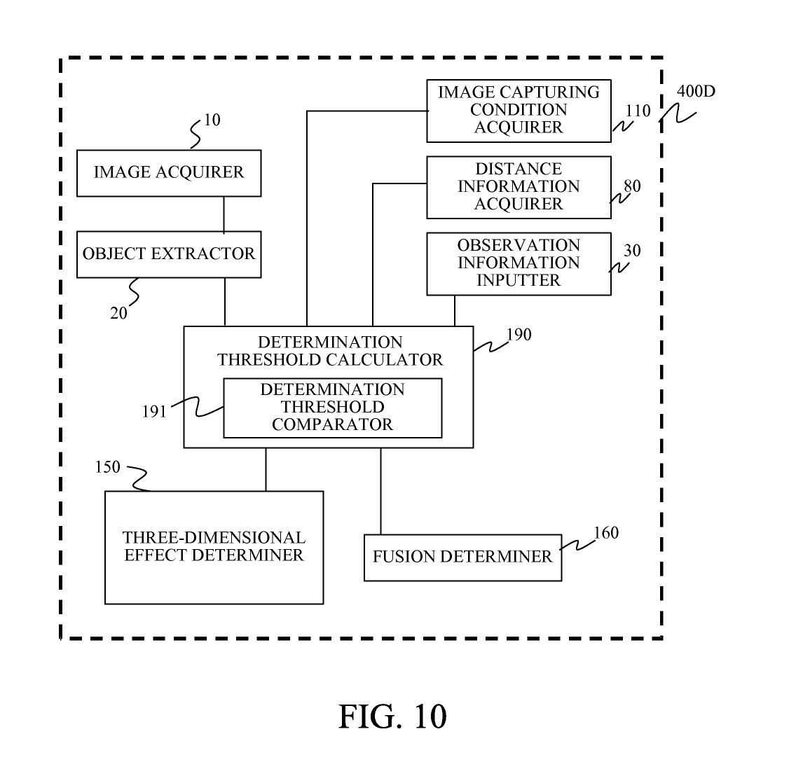

Next, description will be made of processes performed by the system controller 106 and the three-dimensional image processor 400C in the three-dimensional image capturing apparatus of this embodiment with reference to FIG. 9. Similarly to Embodiment 1, the system controller 106 and the three-dimensional image processor 400C perform the following processes (operations) according to a three-dimensional image capturing program as a computer program.

First at step S401, similarly to step S101 in Embodiment 1, the system controller 106 causes the image processor 104 to produce the left and right parallax images. The three-dimensional image processor 400C (image acquirer 10) acquires the left and right parallax images produced by the image processor 104.

Next, at step S402, similarly to step S102 in Embodiment 1, the three-dimensional image processor 400C (object extractor 20) extracts (selects) the specific object from the parallax images. In this example, the person enclosed by solid lines illustrated in FIG. 16 is extracted as the specific object. The object extractor 20 also extracts objects other than the specific object.

Next, at step S403, the three-dimensional image processor 400C (image capturing condition acquirer 110 and observation condition acquirer 30) acquires the image capturing conditions and the observation conditions. The image capturing condition acquirer 110 acquires the above-mentioned image capturing conditions through the state detector 107 and the system controller 106. Information on the image capturing conditions acquired through the state detector 107 may be temporarily recorded in the recorder 108 or a memory (not illustrated) in the three-dimensional image capturing apparatus, and the image capturing condition acquirer 110 may read out information on the recorded image capturing conditions as necessary. Similarly to step S103 in Embodiment 1, the observation condition acquirer 30 acquires the observation conditions.

Next, at step S404, the three-dimensional image processor 400C (distance information acquirer 80) acquires, among the multiple objects extracted at step S402, object distances of two or more objects included in an image region as a ranging target (the image region is hereinafter referred to as “a ranging region”) in each of the parallax images. The ranging region may be entire region of each parallax image or a partial region thereof. The object distances thus acquired are used in the fusion possibility determination and the three-dimensional effect determination. The fusion possibility determination uses, among the object distances of the objects in the parallax image (ranging region), an object distance (minimum distance) y1n of a nearest object nearest to the three-dimensional image capturing apparatus and an object distance (maximum distance) y1f of a farthest object farthest from the three-dimensional image capturing apparatus. The three-dimensional effect determination uses object distances of nearer and farther parts (the evaluation points i and j in FIG. 16) of the specific object selected at step S402. Steps S401 to S404 described so far may be performed in a different order.

Next, at step S405, the three-dimensional image processor 400C (determination threshold calculator 90) calculates the base length necessary for the nearest object and the farthest object (in other words, all objects included in a distance range whose limits are at these objects; hereinafter also simply referred to as “whole objects”) to be included in the fusion allowing range. Expression (35) can be rewritten for the base length we as following expression (41).

$$wc \leq ξ \cdot \frac{y {1}_{f} \cdot y {1}_{n}}{y {1}_{f} - y {1}_{n}} \cdot \frac{ds \cdot ccw}{scw \cdot f} \qquad ( 41 )$$

The base length necessary for the whole objects to be included in the fusion allowing range can derived by calculating a value on the right-hand side of this Expression (41). The determination threshold calculator 90 calculates an upper limit of the base length (hereinafter referred to as “a fusion upper limit base length”) on the right-hand side of expression (41) by using the image capturing conditions and the observation conditions acquired at step S403, the object distances y1n and y1f acquired at step S404 and the fusional limit ξ. This fusion upper limit base length is used as the determination threshold in the fusion possibility determination, and referred to in controlling the base length. The determination threshold calculator 90 temporarily records the fusion upper limit base length to the recorder 108 or a memory (not illustrated).

Next, step S406 as the fusion possibility determination step), the three-dimensional image processor 400C (fusion determiner 160) performs the fusion possibility determination. Specifically, the fusion determiner 160 determines whether or not expression (41) is satisfied, in other words, whether or not the base length (hereinafter referred to as “an image capturing base length”) wc among the image capturing conditions acquired at step S403 is equal to or smaller than the fusion upper limit base length calculated at step S405. If expression (41) is satisfied, the whole objects are included in the fusion allowing range. In this case, a process at step S407 is performed. If expression (41) is not satisfied, at least part of the whole objects is out of the fusion allowing range. In this case, a process at step S408 is performed.

At step S408, the system controller 106 performs a control to shorten the base length by reducing a relative parallax amount (absolute value) as a difference between a parallax amount of the nearest object and a parallax amount of the farthest object so that the whole objects are included in the fusion allowing range. As described in Embodiment 1, expression (37) shows that a longer base length wc provides a larger absolute value of the relative parallax amount and that a shorter base length wc provides a smaller absolute value of the relative parallax amount. For this reason, the system controller 106 controls the optical driver 105 to shorten the base length wc by a predetermined amount. After the base length is thus shortened, the fusion determiner 60 performs the fusion possibility determination again at step S406. When the whole objects are not included in the fusion allowing range, the system controller 106 shortens the base length by the predetermined amount again at step S408. In this manner, after this adjustment (reduction) of the base length is performed until the whole objects are included in the fusion allowing range, the three-dimensional image processor 400C proceeds to step S407.

At step S407, the three-dimensional image processor 400C (determination threshold calculator 90) calculates the base length necessary for the observer to feel the three-dimensional effect of the specific object.

Expression (27) can be rewritten for the base length wc as following expression (42).

$$wc \geq \frac{δ t \cdot ds \cdot ccw}{2 \cdot scw \cdot f} \cdot \frac{y {1}_{i} \cdot y {1}_{j}}{\vert y {1}_{j} - y {1}_{i} \vert} \qquad ( 42 )$$

Expression (31) can be rewritten for the base length wc as following expression (43).

$$wc \geq \vert \frac{δ t \cdot ds \cdot ccw \cdot y {1}^{2}}{2 \cdot Δ \cdot scw \cdot f} \vert \qquad ( 43 )$$

Calculating a value on the right-hand side of expression (42) or (43) provides a base length necessary for the observer to feel the three-dimensional effect of the specific object including the evaluation points i and j or of the thickness Δ of the specific object (the base length is hereinafter referred to as “a three-dimensional effect determination base length”).

As described above in this embodiment, the three-dimensional effect determination may be performed based on expression (42) using information on object distances (y1n and y1f) of two objects or may be performed based on expression (43) using a distance (y1) of one object and a thickness Δ of this object. Since the thickness Δ corresponds to, for example, a distance between the evaluation points i and j in FIG. 16, the use of the thickness Δ is equivalent to the use of the distances of these evaluation points i and j.

To perform the three-dimensional effect determination by using expression (43), information on the thickness Δ is needed. When the three-dimensional effect determination is performed, an identical value may be used as the thickness Δ of any object, or different values may be used for respective objects. When such different values are used for the respective objects, each object needs to be identified and the specific thickness Δ needs to be set for the identified object. In this case, for example, the template matching method described above may be used to identify the object through comparison to a previously prepared base image and read out the thickness Δ of the identified object from data of a thickness for each object previously recorded in a memory. To set the thickness Δ more appropriately, data of thicknesses for larger numbers of base images and objects are needed, the memory storing this data does not necessarily need to be provided in the three-dimensional image capturing apparatus. For example, the thickness Δ may be acquired from a record apparatus externally disposed through communication such as wireless communication.

Next, description will be made of a case of performing the three-dimensional effect determination by using expression (42). To perform the three-dimensional effect determination by using expression (42), the determination threshold calculator 90 calculates the three-dimensional effect determination base length by expression (42) using the image capturing conditions and the observation conditions acquired at step S403, the object distance of the specific object acquired at step S404 and the lowest allowable parallax value δt. This three-dimensional effect determination base length is used as the determination threshold in the three-dimensional effect determination as described above. The three-dimensional effect determination base length is referred to in controlling the base length. For this purpose, the determination threshold calculator 90 temporarily records the three-dimensional effect determination base length in the recorder 108 or a memory (not illustrated).

Next, at step S409 as a three-dimensional effect determination step, the three-dimensional image processor 400C (three-dimensional effect determiner 150) determines whether or not the three-dimensional effect of the specific object is provided. First, the three-dimensional effect determiner 150 selects the evaluation point at which the three-dimensional effect is evaluated. In this selection, for example, as described for step S107 in Embodiment 1, the head of the nose of the person illustrated in FIG. 16 is selected as the evaluation point i, and each of the ears thereof is selected as the evaluation point j. The evaluation points may be selected by the method described for step S107 in Embodiment 1.

Next, the three-dimensional effect determiner 150 determines whether or not expression (42) is satisfied, in other words, whether or not the image capturing base length we is equal to or larger than the three-dimensional effect determination base length. If expression (42) is satisfied, the three-dimensional effect determiner 150 determines that the observer can feel the three-dimensional effect of the specific object including the evaluation points i and j. If expression (42) is not satisfied, the three-dimensional effect determiner 150 determines that the observer cannot feel the three-dimensional effect of the specific object including the evaluation points i and j.

In this embodiment, the three-dimensional effect determination is performed by using expression (42) at step S409, but since the lowest allowable parallax value δt is a statistic by a subjective evaluation, results of the three-dimensional effect determination may have a slight difference depending on observers. Thus, as indicated in expression (44) below, the three-dimensional effect determination may be performed by correcting (changing) the determination threshold with the correction value C depending on a difference in three-dimensional effect between individual observers.

$$wc \geq \frac{C \cdot δ t \cdot ds \cdot ccw}{scw \cdot f} \cdot \frac{y {1}_{i} \cdot y {1}_{j}}{\vert y {1}_{j} - y {1}_{i} \vert} \qquad ( 44 )$$

The correction value C may be a value recorded as an initial condition in a memory (not illustrated) or may be input by the user through the input interface described above.

When it is determined at step S409 that the three-dimensional effect of the specific object is not provided, the three-dimensional effect of the specific object needs to be further increased. For this purpose, at step S411, the system controller 106 controls the optical driver 105 to extend the base length wc of the left and right image capturing optical systems 201 and 101 by a predetermined amount. This is because expression (23) shows that three-dimensional effect of the object increases as the base length wc of the left and right image capturing optical systems 201 and 101 increases.

The fusion upper limit base length necessary for the whole objects to be included in the fusion allowing range has been calculated at step S405, and the three-dimensional effect determination base length as a lower limit of the base length for providing the three-dimensional effect to the specific object, which is a target to be three-dimensionally observed, has been also calculated. Thus, the system controller 106 controls the base length with reference to the fusion upper limit base length and the three-dimensional effect determination base length so that expression (42) (or (44)) and expression (41) are satisfied. Controlling the base length in this manner enables reliably and efficiently providing a good three-dimensional effect.

On the other hand, when it is determined at step S409 that the three-dimensional effect of the specific object is provided, since it has already been determined at step S406 that the whole objects are included in the fusion allowing range, image capturing in this state can produce left and right parallax images allowing three-dimensional image fusing of each of the whole objects by the observer (that is, preventing the observer from recognizing them as a double image) and allowing the observer to feel a sufficient three-dimensional effect of the specific object. Accordingly, at step S410, the system controller 106 performs image capturing similarly to step S401 (step S101 in Embodiment 1) to acquire such left and right parallax images, and display these images on the image display unit 600 or records them to the recorder 108.

When it is determined that each object in the parallax images acquired at step S401 are included in the fusion allowing range and the three-dimensional effect of the specific object is provided, the parallax images acquired at step S401 may be displayed or recorded without any correction.

As described above, this embodiment also can easily produce the parallax images providing a sufficient three-dimensional effect of the specific object and allowing the three-dimensional image fusion of each object by the observer, by controlling the image capturing parameters depending on the results of the fusion possibility determination and the three-dimensional effect determination.

This embodiment has described the case of determining the fusion possibility determination and the three-dimensional effect determination using the base length, the fusion possibility determination and the three-dimensional effect determination may be performed by using the focal length.

When the fusion possibility determination is performed by using the focal length, expression (41) needs to be rewritten as following expression (45).

$$f \leq ξ \cdot \frac{y {1}_{f} \cdot y {1}_{n}}{y {1}_{f} - y {1}_{n}} \cdot \frac{ds \cdot ccw}{scw \cdot wc} \qquad ( 45 )$$

In addition, expressions (42) and (43) need to be rewritten as following expressions (46) and (47).

$$\begin{matrix}f \geq \frac{δ t \cdot ds \cdot ccw}{2 \cdot scw \cdot wc} \cdot \frac{y {1}_{i} \cdot y {1}_{j}}{\vert y {1}_{j} - y {1}_{i} \vert} & ( 46 ) \\ f \geq \vert \frac{δ t \cdot ds \cdot ccw \cdot y {1}^{2}}{2 \cdot Δ \cdot scw \cdot wc} \vert & ( 47 )\end{matrix}$$

Performing the fusion possibility determination and the three-dimensional effect determination using these expressions (45) to (47) enables adjusting the three-dimensional effect by controlling the focal length. As indicate by expression (37) described above, the three-dimensional effect increases as the focal length f increases, and in other words, the three-dimensional effect decreases as the focal length f decreases. Thus, the three-dimensional effect can be adjusted by controlling the focal length.

The determination expressions for performing the fusion possibility determination and the three-dimensional effect determination in this embodiment each directly compare the image capturing parameter such as the base length or the focal length in its left-hand side with the calculation result in its right-hand side. However, the determinations may be performed by obtaining a value of an expression (a left-hand side thereof) such as expression (27) and expression (35) into which values of the image capturing and observation parameters are substituted and by comparing the obtained value with the lowest allowable parallax value δt and the fusional limit ξ.

### Embodiment 5

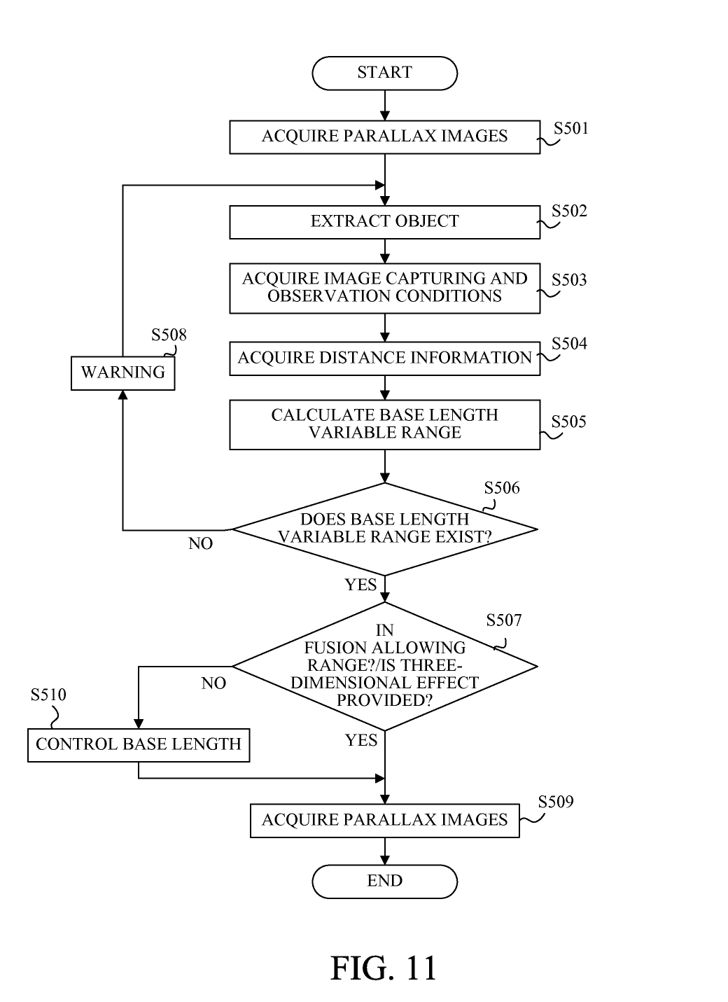

Next, description will be made of a three-dimensional image capturing apparatus that is a fifth (Embodiment 5) with reference to FIG. 10. The three-dimensional image capturing apparatus of this embodiment has the same whole configuration as that of the three-dimensional image capturing apparatus in Embodiment 1 (and Embodiment 4), and components common to those in Embodiment 1 (and Embodiment 4) are denoted by the same reference numerals as those in Embodiment 1 (and Embodiment 4). In this embodiment, a three-dimensional image processor 400D includes a determination threshold calculator 190 that is different from the determination threshold calculator 90 in the three-dimensional image processor 400C in Embodiment 4. Specifically, the determination threshold calculator 190 stores the fusional limit as a determination threshold calculated by the determination threshold calculator 190 and includes a determination threshold comparator 191 that compares the fusional limit ξ.

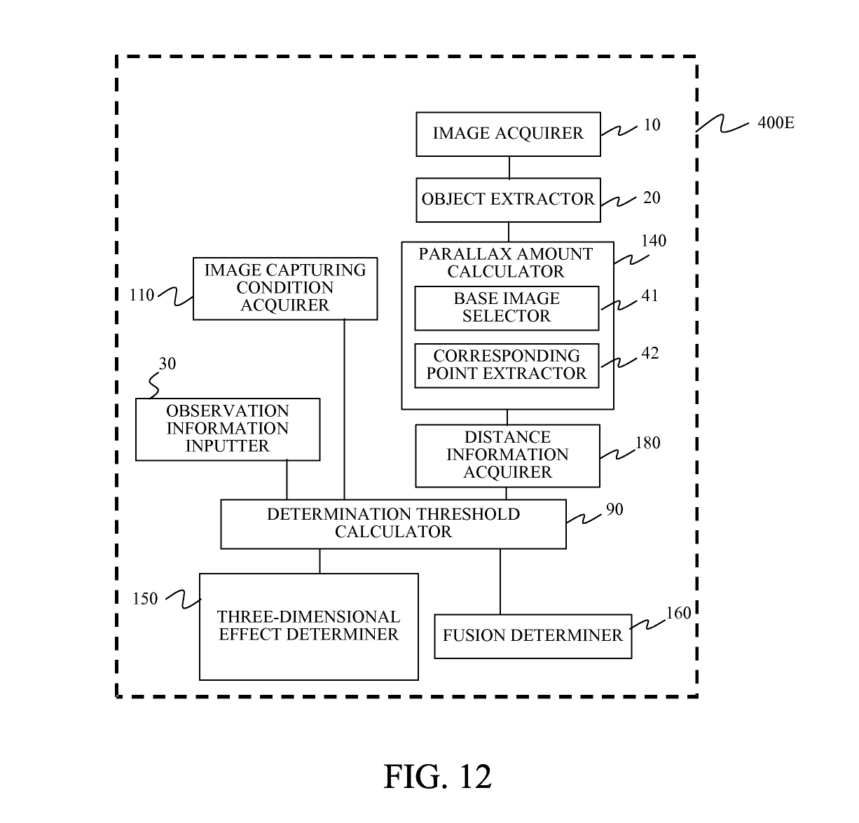

Next, description will be made of processes performed by the system controller 106 and the three-dimensional image processor 400D in the three-dimensional image capturing apparatus of this embodiment with reference to a flowchart shown in FIG. 11. Similarly to Embodiment 1 (and Embodiment 4), the system controller 106 and the three-dimensional image processor 400D perform the following processes (operations) according to a three-dimensional image capturing program as a computer program.

Steps S501 to S504 are the same as steps S401 to S404 described in Embodiment 4, and description thereof will be omitted.

At step S505, the three-dimensional image processor 400D (determination threshold calculator 190) calculates the determination thresholds used in the fusion possibility determination and the three-dimensional effect determination. Specifically, the determination threshold calculator 190 calculates the fusion upper limit base length by expression (41) using the image capturing and observation conditions acquired at step S503 and the object distance and the fusional limit ξ acquired at step S504. The determination threshold calculator 190 also calculates the three-dimensional effect determination base length by expression (42) or (43) using the image capturing conditions, the observation conditions, the object distance of the specific object and the lowest allowable parallax value δt. Alternatively, as in expression (44), the three-dimensional effect determination base length corrected by using the correction value C may be calculated. The determination threshold calculator 190 temporarily records the fusion upper limit base length and the three-dimensional effect determination base length thus calculated to the recorder 108 or a memory (not illustrated).

Next, at step S506, the three-dimensional image processor 400D (determination threshold comparator 191) compares the fusion upper limit base length calculated at step S505 with the three-dimensional effect determination base length calculated thereat. In order to allow the whole objects to be included in the fusion allowing range and to provide a sufficient three-dimensional effect of the specific object, the base length we may be controlled within a base length variable range whose upper limit is the fusion upper limit base length and whose lower limit is the three-dimensional effect determination base length. In other words, when the fusion upper limit base length is longer than the three-dimensional effect determination base length, the base length variable range is provided which allows an adjustment of the base length in this range for enabling presentation of a desired three-dimensional image. On the other hand, when the fusion upper limit base length is shorter than the three-dimensional effect determination base length, the base length variable range is not provided, which means that not all the objects can be included in the fusion allowing range and no three-dimensional effect of the specific object can be provided.

Thus, when the fusion upper limit base length is longer than the three-dimensional effect determination base length (the base length variable range is provided), a process at step S507 is performed. On the other hand, the fusion upper limit base length is shorter than the three-dimensional effect determination base length (the base length variable range is not provided), a process at step S508 is performed.

At step S508, since not all the objects can be included in the fusion allowing range and no three-dimensional effect of the specific object can be provided under current image capturing and observation conditions, the system controller 106 warns the user (photographer) to change the image capturing conditions or the observation conditions.

The warning can be performed by, for example, displaying a warning message on the image display unit 600. In addition to the warning message, advice such as how to adjust the focal length and the base length may be displayed to the user. The warning may be performed by other means such as voice.

Once the user adjusts the image capturing parameter (the focal length or the base length) in response to the warning, the system controller 106 performs image capturing again at step S501 to acquire the left and right parallax images.

On the other hand, at step S507, the base length can be adjusted in the base length variable range so that the whole objects are included in the fusion allowing range and the three-dimensional effect of the specific object is provided. Thus, the fusion determiner 60 performs the fusion possibility determination, in other words, determines whether or not expression (41) as a fusion possibility determination expression is satisfied. The three-dimensional effect determiner 50 performs the three-dimensional effect determination, in other words, determines whether or not expression (42) (or (44)) or (43), which is a three-dimensional effect determination expression, is satisfied.

When the fusion possibility determination expression and the three-dimensional effect determination expression are both satisfied, the current base length allows the whole objects to be included in the fusion allowing range and the three-dimensional effect of the specific object is provided. In this case, a process at step S509 is performed. On the other hand, when at least one of the fusion possibility determination expression and the three-dimensional effect determination expression is not satisfied, the current base length does not allow at least part of the whole objects to be included in the fusion allowing range or the three-dimensional effect of the specific object is not provided. In this case, the base length needs be changed, and thus the system controller 106 proceeds to step S510 to control the base length. The control of the base length has been described for steps S408 and S409 in Embodiment 4.

When the base length is controlled at step S510 or when both the fusion possibility determination expression and the three-dimensional effect determination expression are satisfied at step S507, the system controller 106 performs image capturing at step S509 similarly to step S409 in Embodiment 4 to acquire the left and right parallax images.

As described above, this embodiment also can easily produce the parallax images providing a sufficient three-dimensional effect of the specific object and allowing the three-dimensional image fusion of each object by the observer, by controlling the image capturing parameters depending on the results of the fusion possibility determination and the three-dimensional effect determination.

### Embodiment 6

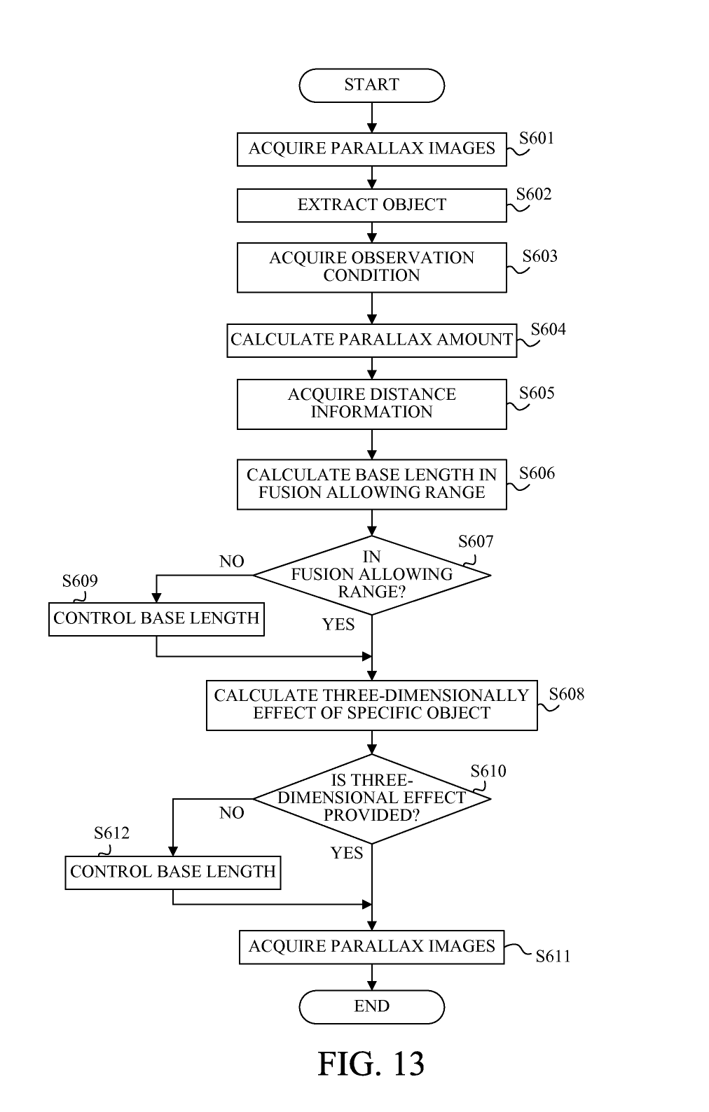

FIG. 12 illustrates a configuration of a three-dimensional image processor 400E in a three-dimensional image capturing apparatus that is a sixth embodiment (Embodiment 6). The three-dimensional image capturing apparatus of this embodiment has the same whole configuration as those of the three-dimensional image capturing apparatuses in Embodiments 1 and 4, and components common to those in Embodiments 1 and 4 are denoted by the same reference numerals as those in Embodiments 1 and 4.

In the three-dimensional image processor 400E, the image acquirer 10, the object extractor 20, the observation condition acquirer 30 and the image capturing condition acquirer 110 that are common to those in the three-dimensional image processor 400C in Embodiment 4 are denoted by the same reference numerals as those in Embodiment 4, and description thereof will be omitted. However, the object extractor 20 in this embodiment extracts only the specific object in the parallax images, unlike the object extractor 20 in Embodiment 4. The three-dimensional image processor 400E has a configuration in which a parallax amount calculator 140 is added to the three-dimensional image processor 400C in Embodiment 4 and the distance information acquirer 80 in the three-dimensional image processor 400C is replaced with a distance information acquirer 180 that calculates an object distance from a parallax amount.

The parallax amount calculator 140 includes the base image selector 41 and the corresponding point extractor 42. The base image selector 41 selects one of the left and right parallax images as a parallax amount calculation base image for calculating the parallax amount, and the other as a parallax amount calculation reference image. The corresponding point extractor 42 extracts multiple pairs of corresponding points (pixels that capture images of an identical object in the left and right parallax images) as corresponding pixels in the left and right parallax images. The parallax amount calculator 140 calculates a parallax amount between each of the multiple pairs of corresponding points extracted by the corresponding point extractor 42. The corresponding point extractor 42 and the object extractor 20 correspond to an extractor.

The distance information acquirer 180 calculates, by using the parallax amount of each pair of corresponding points calculated by the parallax amount calculator 140, an object distance to each pair of corresponding points (that is, to each object).

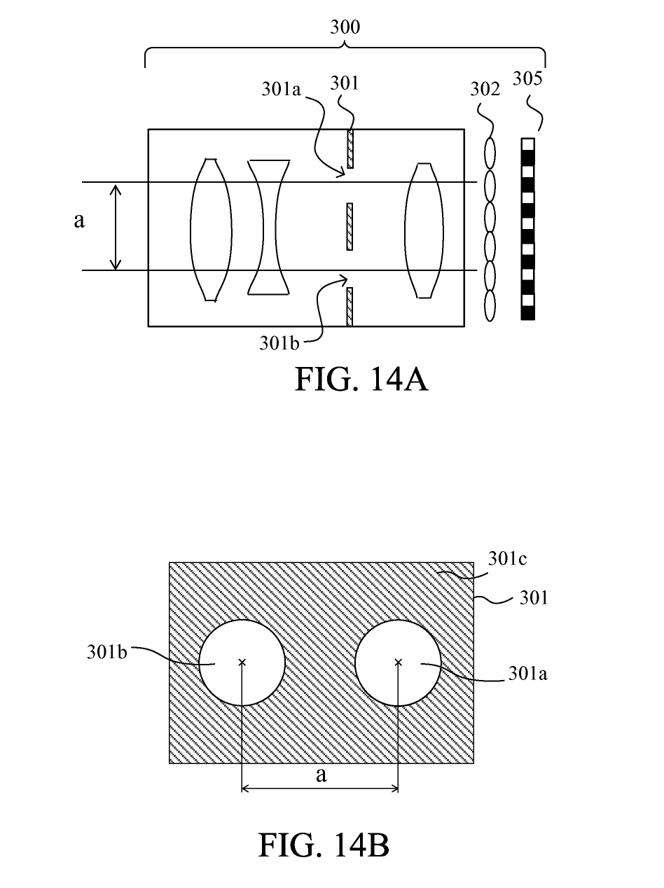

Next, description will be made of processes performed by the system controller 106 and the three-dimensional image processor 400E in the three-dimensional image capturing apparatus of this embodiment with reference to a flowchart shown in FIG. 13. Similarly to Embodiment 1, the system controller 106 and the three-dimensional image processor 400E perform the following processes (operations) according to a three-dimensional image capturing program as a computer program.

Steps S601 to S603 are the same as steps S101 to S103 described in Embodiment 1, and description thereof will be omitted.

At step S605, the three-dimensional image processor 400E (parallax amount calculator 140) calculates the parallax amount of the specific object extracted at step S602. The parallax amount calculator 140 first causes the base image selector 41 to select one of the left and right parallax images as the parallax amount calculation base image and the other as the parallax amount calculation reference image. Next, the parallax amount calculator 140 causes the corresponding point extractor 42 to extract the multiple pairs of corresponding points at multiple positions in the base and reference images. The method of extracting the corresponding points has been described for step S104 in Embodiment 1.

Next, the parallax amount calculator 140 calculates the parallax amount (Pl-Pr) between each of the multiple pairs of corresponding points extracted at the multiple positions. The method of calculating the parallax amount (Pl-Pr) has been described for step S104 in Embodiment 1.

Next, at step S605, the distance information acquirer 180 calculates the object distances based on the corresponding points calculated by the parallax amount calculator 140, in other words, the parallax amounts (Pl-Pr) of the objects. Expressions (1) and (2) and expressions (3) and (4) provide the object distance y1 as expressed by following expression (48).

$$y 1 = \frac{2 \cdot scw \cdot wc \cdot f}{ccw \cdot ( Pl - Pr )} \qquad ( 48 )$$

The use of expression (48) allows the object distance y1 to be calculated from the parallax amount (Pl-Pr). An image region in which the object distance is acquired may be an entire region of each parallax image or a partial region thereof. Information on the object distance thus acquired is used in the fusion possibility determination and the three-dimensional effect determination. The fusion possibility determination uses, among the object distances of the objects in the parallax image (ranging region), an object distance (minimum distance) y1n of a nearest object nearest to the three-dimensional image capturing apparatus and an object distance (maximum distance) y1f of a farthest object farthest from the three-dimensional image capturing apparatus. The three-dimensional effect determination uses object distances of nearer and farther parts (the evaluation points i and j in FIG. 16) of the specific object selected at step S602. Steps S601 to S605 described so far may be performed in a different order.

Next, at step S606, similarly to step S405 in Embodiment 4, the three-dimensional image processor 400E (determination threshold calculator 90) calculates the fusion upper limit base length that is the base length necessary for the whole objects to be included the fusion allowing range by using expression (41) and calculates a lower limit base length thereof. Then, the determination threshold calculator 90 temporarily records the fusion upper limit base length and the lower limit base length to the recorder 108 or a memory (not illustrated).

Next, at step 607 as a fusion possibility determination step, similarly to step S406 in Embodiment 4, the three-dimensional image processor 400E (fusion determiner 60) performs the fusion possibility determination (that is, determines whether or not expression (41) is satisfied). If expression (41) is satisfied, which means that the whole objects are in the fusion allowing range, a process at step S608 is performed. If expression (41) is not satisfied, which means that at least part of the whole objects is out of the fusion allowing range, a process at step S609 is performed.

At step S609, similarly to step S408 in Embodiment 4, the system controller 106 performs a control to shorten the base length by reducing the relative parallax amount (absolute value) as the difference between the parallax amounts of the nearest object and the farthest object so that the whole objects are included in the fusion allowing range.

On the other hand, at step S608, similarly to step S407 in Embodiment 4, the three-dimensional image processor 400E (determination threshold calculator 90) calculates the three-dimensional effect determination base length as the base length necessary for the observer to feel the three-dimensional effect. The determination threshold calculator 90 temporarily records this three-dimensional effect determination base length in the recorder 108 or a memory (not illustrated).

Next, at step S610 as a three-dimensional effect determination step, similarly to step S107 in Embodiment 1, the three-dimensional image processor 400E (three-dimensional effect determiner 50) performs the three-dimensional effect determination. In other words, the three-dimensional effect determiner 50 determines whether or not expression (25) (or expression (38)) is satisfied by using the parallax amount of the specific object calculated at step S604 and the lowest allowable parallax value δt. If expression (25) is satisfied, the observer can feel the three-dimensional effect of the specific object, and therefore it is determined that the three-dimensional effect of the specific object is provided. On the other hand, if expression (25) is not satisfied, the observer cannot feel the three-dimensional effect of the specific object, and therefore it is determined that the three-dimensional effect of the specific object is not provided.

When it is determined that the three-dimensional effect of the specific object is not provided, the three-dimensional effect of the specific object needs to be further increased. For this purpose, at step S612, the system controller 106 controls the optical driver 105 to extend the base length we of the left and right image capturing optical systems 201 and 101 by a predetermined amount. In this control, as described for step S411 in Embodiment 4, the system controller 106 controls the base length with reference to the fusion upper limit base length and the three-dimensional effect determination base length so that expression (42) (or (44)) and expression (41) are satisfied.

On the other hand, when it is determined that the three-dimensional effect of the specific object is provided, it has already been determined at step S607 that the whole objects are included in the fusion allowing range. Thus, at step S610, the system controller 106 performs image capturing, similarly to step S601 (step S101 in Embodiment 1), to acquire the left and right parallax images, displays these images on the image display unit 600 and records them in the recorder 108. When it is originally determined that the whole objects in the parallax images acquired at step S601 are included in the fusion allowing range and the three-dimensional effect of the specific object is provided, the parallax images acquired at step S601 may be displayed or recorded without any correction.

As described above, this embodiment also can easily produce the parallax images providing a sufficient three-dimensional effect of the specific object and allowing the three-dimensional image fusion of each object by the observer, by controlling the image capturing parameters depending on the results of the fusion possibility determination and the three-dimensional effect determination.

### Embodiment 7

Next, description will be made of a seventh embodiment (Embodiment 7) of the present invention. Embodiments 1 to 6 have described the case of changing the base length by changing the distance between the left and right image capturers (that is, between the image capturing optical systems 201 and 101 and between the image sensors 202 and 102) separate from each other. However, the base length may be changed when the left and right image capturers are integrated.

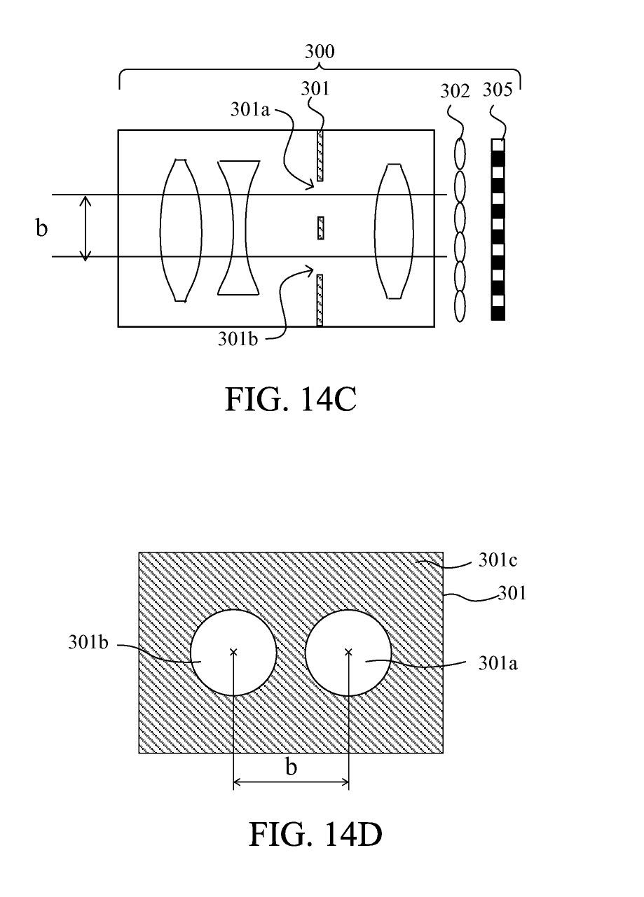

FIGS. 14A to 14D each illustrate an integrated image capturer of a three-dimensional image capturing apparatus of Embodiment 7. This integrated image capturer includes one image capturing optical system 300 that includes multiple lenses (focus lens and magnification-varying lens) arranged in an optical axis direction, a liquid crystal shutter 301 disposed at a position of an aperture stop and a micro lens 302. The integrated image capturer includes one image sensor 305 that photoelectric converts an object image formed by the image capturing optical system 300.

The liquid crystal shutter 301 forms light-transmitting portions 301a and 301b separately arranged on right and left sides and a light-shielding portion 301c surrounding the light-transmitting portions 301a and 301b, by controlling light transmittance through voltages applied to its liquid crystals, as illustrated in FIGS. 14A and 14B. A light flux entering the image capturing optical system 300 from an object and passing through the light-transmitting portions 301a and 301b as apertures of the liquid crystal shutter 301 enters the micro lens 302. The light flux passing through the right light-transmitting portion 301a passes through the micro lens 302 and enters a right-image pixel (white part in FIG. 14A) of the image sensor 305. On the other hand, the light flux passing through the left light-transmitting portion 301b passes through the micro lens 302 and enters a left-image pixel (black part in FIG. 14A) of the image sensor 305. A right image produced using an output from the right-image pixel and a left image produced using an output from the left-image pixel are left and right parallax images having a parallax therebetween. The multiple lenses, the right light-transmitting portion 301a of the liquid crystal shutter 301, the micro lens 302 and the right-image pixel of the image sensor 305 are included in a right image capturer of two image capturers. The multiple lenses, the left light-transmitting portion 301b of the liquid crystal shutter 301, the micro lens 302 and the right-image pixel of the image sensor 305 are included in a left image capturer of the two image capturers.

Moving positions of the light-transmitting portions 301a and 301b formed in the liquid crystal shutter 301 in a direction of their arrangement so as to change their interval can change (increase or decrease) the base length in the image capturing optical system 300. FIGS. 14A and 14B each illustrate a state in which the interval of the light-transmitting portions 301a and 301b is equal to a, and FIGS. 14C and 14D each illustrate a state in which the interval of the light-transmitting portions 301a and 301b is equal to b shorter than a.

This embodiment has described the case of changing the base length using the liquid crystal shutter, but positions of apertures through which light fluxes pass may be mechanically changed by using a mechanical shutter.

Each of the embodiments enables easily producing the parallax images that provides a sufficient three-dimensional effect of the specific object and that allows the three-dimensional image fusion of each object by the observer, by controlling the image capturing parameters depending on the results of the fusion possibility determination and the three-dimensional effect determination.

### Other Embodiments

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2014-179633, filed on Sep. 3, 2014, which is hereby incorporated by reference wherein in its entirety.

What is claimed is:

1. A three-dimensional image capturing apparatus comprising:
an image capturer configured to perform image capturing to produce parallax images mutually having a parallax;
an extractor configured to extract an object included in the parallax images;
a first determiner configured to determine whether or not the parallax images allow three-dimensional image fusion by an observer observing the parallax images, by using (a) determination-purpose information on one of a parallax amount of the object between the parallax images and a distance to the object at the image capturing and (b) a fusional limit that is an upper limit of the parallax amount allowing the three-dimensional image fusion by the observer;
a second determiner configured to determine a three-dimensional effect of the object in the observation of the parallax images, by using the determination-purpose information and a lowest allowable parallax value that is a lower limit of the parallax amount allowing the observer to feel the three-dimensional effect; and
a controller configured to control an image capturing parameter in the image capturer depending on determination results by the first and the second determiners.

2. A three-dimensional image capturing apparatus according to claim 1, wherein the first determiner is configured to determine whether or not the parallax images allow the three-dimensional image fusion, by using a maximum parallax amount and a minimum parallax amount of the parallax amounts of multiple objects each included in the parallax images as the object.

3. A three-dimensional image capturing apparatus according to claim 1, wherein the first determiner is configured to determine whether or not the parallax images allow the three-dimensional image fusion, by using a maximum distance and a minimum distance of the distances to multiple objects each included in the parallax images as the object.

4. A three-dimensional image capturing apparatus according to claim 3, wherein the first determiner is configured to calculate the distance to the object, by using the parallax amount of the object and an image capturing condition at the image capturing.

5. A three-dimensional image capturing apparatus according to claim 1, wherein the second determiner is configured to change a determination threshold for determining the lowest allowable parallax value or for determining the three-dimensional effect, depending on an individual difference of each observer.

6. A three-dimensional image capturing apparatus according to claim 1, wherein a determination threshold for at least one of the determination of whether or not the parallax images allow the three-dimensional image fusion and the determination of the three-dimensional effect is allowed to be changed, depending on a process on the parallax images.

7. A three-dimensional image capturing apparatus according to claim 1, wherein the controller is configured to control at least one of a base length and a focal length of the image capturer as the image capturing parameter.

8. A non-transitory computer-readable storage medium storing a three-dimensional image capturing program as a computer program that causes a computer of a three-dimensional image capturing apparatus to perform an image capturing control process, the image capturing apparatus including an image capturer configured to perform image capturing to produce parallax images mutually having a parallax, the image capturing control process comprising:
extracting an object included in the parallax images;
acquiring determination-purpose information on one of a parallax amount of the object between the parallax images and a distance to the object at the image capturing;
determining whether or not the parallax images allow three-dimensional image fusion by an observer observing the parallax images, by using the determination-purpose information and a fusional limit that is an upper limit of the parallax amount allowing the three-dimensional image fusion by the observer;
determining a three-dimensional effect of the object in the observation of the parallax images, by using the determination-purpose information and a lowest allowable parallax value that is a lower limit of the parallax amount allowing the observer to feel the three-dimensional effect; and
controlling an image capturing parameter in the image capturer depending on a determination result of whether or not the parallax images allow the three-dimensional image fusion and a determination result of the three-dimensional effect.
